(19) United States
(12) Patent Application Publication
(10) Pub. No.: US 2024/0376283 A1
(43) Pub. Date: Nov. 14, 2024

(54) METHOD FOR PRODUCING COATED NON-CROSSLINKING POLYMER MATERIALS

(71) Applicant: BASF COATINGS GMBH, Muenster (DE)

(72) Inventors: Karin REUTER, Muenster (DE); Florian GUTSCHE, Muenster (DE); Simon WINZEN, Muenster (DE)

(21) Appl. No.: 18/690,769

(22) PCT Filed: Sep. 30, 2022
(86) PCT No.: PCT/EP22/77358

§ 371 Date: Mar. 11, 2024

(30) Foreign Application Priority Data
Oct. 11, 2021 (EP) 21201944.2

(51) Int. Cl. C08J 9/34; A43B 13/02; B29C 44/06; B29C 44/34; B29K 75/00; B29K 105/00; B29K 105/04; B29L 31/50; C09D 5/20; C09D 7/65; C09D 175/06

(52) U.S. Cl. CPC C08J 9/34; B29C 44/06; B29C 44/3419; B29C 44/3426; C09D 5/20; C09D 7/65; C09D 175/06; A43B 13/026; B29K 2075/00; B29K 2105/0005; B29K 2105/04; B29K 2905/02; B29L 2031/504; C08J 2375/04; C08J 2475/06

(57) ABSTRACT

Described herein is a process for producing molded non-crosslinked polymer materials including at least one at least partially coated surface, where a coating composition having release agent properties is used to coat the non-crosslinking polymer material. The coated materials show good optical properties as well as a good mechanical stability as well as a high flexibility. Further described herein are molded non-crosslinked polymer materials including at least one at least partially coated surface, which are produced by the process.

The present invention relates to a process for producing molded non-crosslinked polymer materials comprising at least one at least partially coated surface, in particular partially coated shoe soles, wherein a coating composition having release agent properties is used to coat the non-crosslinking polymer material. The coated materials show good optical properties, in particular a good appearance, as well as a good mechanical stability, in particular a high adhesion of the coating layer to the non-crosslinked polymer material as well as a high flexibility. The present invention moreover relates to molded non-crosslinked polymer materials comprising at least one at least partially coated surface, in particular coated shoe soles, which are produced by the inventive process.

### STATE OF THE ART

A wide variety of different components with variable layer thicknesses are nowadays mostly produced by means of molding processes, like injection molding and casting processes. A greatly used material in molding processes are polymer foams. Polymer foams belong to the solid foam family which are versatile materials, extensively used for a large number of applications such as automotive, packaging, sport products, thermal and acoustic insulators, tissue engineering or liquid absorbents. Composed of air bubbles entrapped in a continuous solid network, they combine the properties of the polymer with those of the foam to create an intriguing and complex material. Polymer foams not only allow to use the wide range of interesting properties that the polymers offers, but also permit to profit from the advantageous properties of foams, including lightness, low density, compressibility and high surface-to-volume ratio.

Foam materials can be divided into crosslinked and non-crosslinked foam materials. In crosslinked foam materials, the polymer chains forming the foam are linked by chemical and/or physical bonds, resulting in foam materials with better tightness, greater flexibility, insulation capacity, cell homogeneity and high durability. In contrast, non-crosslinked foam materials do not comprise any chemical and/or physical bonds between the polymer chains and are normally expanded using gas.

Structural foam molded thermoplastics exhibit a characteristic swirl pattern or a mottled surface that can be attractive on durable outdoor, industrial or factory applications. However, the as-molded structural foam appearance isn't appropriate for all products. Particularly in the area of the production of footwear soles or in the area of the furniture industry, there is a sustained demand for foam components produced by molding process having an attractive appearance. One way of providing such an attractive appearance is by post-treatment of the molded parts, for example by sanding and coating. Coatings can be applied for aesthetic purposes or to reduce damage of the foam material from environmental influences.

Such processes, however, are inefficient, since they necessitate a further process step after production. Moreover, the external release agent used when producing the molded foam materials to permit damage-free demolding of the formed material from the molding tool has to be removed prior to applying further coating layers to ensure sufficient adhesion of the further coating layers on the molded foam material. This removal, however, requires costly and inconvenient cleaning processes. Further disadvantages associated with the use of external mold release agents include a frequent lack of compatibility between the release agent and the foam composition used to prepare the molded foam material and/or between the release agent and the molding tool, leading to adhesion problems. When external release agents are used, there is an increase in the cost and complexity of the process and hence in the operating times. Furthermore, the use of external release agents leads frequently to shiny surfaces on the components produced, this being unwanted especially in the footwear industry.

Thus, there still remains a need for processes for preparing molded non-crosslinked polymer materials, in particular molded non-crosslinked foam materials, which are at least partially coated with a coating layer, especially coated shoe soles made by molding processes using non-crosslinking polymer foam compositions, wherein the coating of the non-crosslinked polymer material can be performed during the molding process, thus rendering post-treatment of said coated materials superfluous. To avoid the use of external release agents, use of the coating composition should not only result in coated non-crosslinked polymer materials but should, at the same time, allow damage-free removal of the coated non-crosslinked polymer materials from the molding tool.

### Object

Accordingly, an object of the present invention is to provide a process which allows to coat molded non-crosslinked polymer materials on at least part of a least one surface of said materials with a coating layer during the molding process without the use of external release agents. The coating layer should have a high adhesion to the non-crosslinked polymer materials and should be sufficiently flexible to prevent breaking of the coating layer upon bending of the material. At the same time, the coating layer should facilitate damage-free removal of the coated non-crosslinked polymer material from the mold, thus rendering the use of external release agents superfluous.

### Technical Solution

The objects described above are achieved by the subject matter claimed in the claims and also by the preferred embodiments of that subject matter that are described in the description hereinafter.

A first subject of the present invention is therefore a process for producing molded non-crosslinked polymer materials comprising at least one at least partially coated surface, said process comprising the following steps in the stated order:
(a) providing a closable, three dimensional mold (MO) having at least two mold parts which are movable relative to each other and which form a mold cavity with at least two inner surfaces (SU),
(b) applying a coating composition (C1) on at least a part of at least one inner surface (SU) and drying the applied coating composition (C1);
(c) optionally inserting at least one material (M1) into the mold (MO) and heating the mold (MO);
(d) closing the mold (MO) and injecting a non-crosslinkable polymer composition (C2) into the closed mold (MO) or introducing a non-crosslinkable polymer composition (C2) into the open mold (MO) and closing said mold (MO);
(e-1) heating the mold (MO) to expand the non-crosslinkable polymer composition (C2) and optionally fuse the expanded non-crosslinkable polymer composition while at least partially curing the coating composition (C1), or
(e-2) heating the mold (MO) to fuse the non-crosslinkable polymer composition (C2) while at least partially curing the coating composition (C1); or
(e-3) hardening the non-crosslinkable polymer composition (C2) while at least partially curing the coating composition (C1);
(f) opening of the mold (MO) and removing the molded non-crosslinked polymer material comprising at least one at least partially coated surface;
(g) optionally post-treating of the material obtained after step (f), wherein the coating composition (C1) comprises
(i) at least one solvent L;
(ii) at least one compound of the general formula (I)

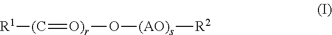

in which R¹ is a saturated or unsaturated aliphatic hydrocarbon radical having 6 to 30 carbon atoms,
R² is H,
AO stands for one or more alkylene oxide radicals selected from the group consisting of ethylene oxide, propylene oxide and butylene oxide,
r is 0 or 1, and
s is 0 to 30;
(iii) at least one polysiloxane of the general formula (II)

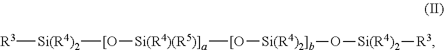

in which
R³ and R⁴, in each case independently of one another, are a methyl group or a (HO—CH₂)₂—C(CH₂—CH₃)—CH₂—O—(CH₂)₃—* radical,
R⁵ is a methyl group,
a is 0 or 1 to 10, and
b is 3 to 30;
(iv) at least one binder;
(v) at least one crosslinking agent; and
(vi) optionally at least one polyether-modified alkylpolysiloxane.

The above-specified process is hereinafter also referred to as process of the invention and accordingly is a subject of the present invention. Preferred embodiments of the process of the invention are apparent from the description hereinafter and also from the dependent claims.

In light of the prior art it was surprising and unforeseeable for the skilled worker that the objects on which the invention is based could be achieved by using a coating composition (C1) which acts as a release agent for the molded material to facilitate damage free removal of the coated material and at the same time allows to coat the non-crosslinked polymer material upon production of the molded non-crosslinked polymer material with a highly flexible coating layer which has a high adhesion to the underlying polymer material. The coating composition (C1) results in a uniform coating having a good appearance and good mechanical properties, irrespective of the polymer composition (i.e. expanded, expandable, pigmented, non-pigmented, polymer melts) used in the process and thus allows to provide aesthetically appealing coated polymer materials, such as foam materials or materials produced from hardening polymer melts, during the molding process. This renders time consuming and cost intensive post-coating to improve the appearance of molded non-crosslinked polymer materials superfluous.

A further subject of the present invention is a molded non-crosslinked polymer material comprising at least one at least partially coated surface obtained by the inventive process.

### DETAILED DESCRIPTION

### Definitions

First of all, a number of terms used in the context of the present invention will be explained.

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

The term “molded non-crosslinked polymer material” as used herein means a polymer material, which has been produced by a molding process, i.e. by a process involving the use of at least one mold, and which does not comprise any polymer chains being crosslinked by at least one chemical bond. These chemical bonds can either be formed by external crosslinking using a crosslinking agent reactive towards the polymer chains or by internal crosslinking via complementary reactive groups within the polymer chains. The molded non-crosslinked polymer material may, however, contain polymer chains being crosslinked by at least one physical bond, for example, by van der Vaals bonding, hydrogen bonding etc., In contrast to chemical crosslinking, physical crosslinking is reversible without destroying the polymer chains within the polymer material. However, it may be likewise preferred if the molded non-crosslinked polymer material does not contain any chemical and physical crosslinks between the polymer chains. Use of polymer materials which are not chemically crosslinked is preferably with respect to recycling aspects, because un-crosslinked or only physically-crosslinked polymer materials are easier to recycle due to the absence of the chemical crosslinking between the polymer chains.

Likewise, the term “non-crosslinkable polymer composition” means a composition comprising at least one polymer and which does not contain any components that are able to react with each other forming chemical and/or physical bonds. The compositions can be present in solid form, such as in the form of granules, particles, etc., or in molten form. The compositions may comprise at least one chemical or physical blowing agent which facilitates expanding of the material in the mold. “Expanding” of the non-crosslinkable polymer composition is understood herein to mean a volume expansion of the non-crosslinkable polymer composition, for example by the use of heat, as compared to the non-expanded non-crosslinkable polymer composition present prior to the heat treatment. “Fusing” the expanded non-crosslinkable polymer composition is understood herein to bond expanded non-crosslinkable polymer particles to each other to obtain a non-crosslinked polymer material. “Hardening” the non-crosslinkable polymer composition is understood herein to harden the molten polymer composition which is injected into the mold to form a non-crosslinked polymer material.

The term “non-crosslinkable polymer material” refers to materials comprising at least one non-crosslinkable polymer. With particular preference, said materials consist of non-crosslinkable polymers. The non-crosslinkable polymers may be the same or may be different. In the latter case, the non-crosslinkable polymer material comprises or consists of at least two different non-crosslinkable polymers. Likewise, the term “non-crosslinkable polymer composition” refers to a composition comprising or consisting of non-crosslinkable polymers. The composition may be in solid form, such as in the form of particles or granules as described previously, or may be a polymer melt.

The term “three dimensional mold” is to be understood herein as referring to molds having a three dimensional inner cavity which is formed by at least two mold parts that can be moved relative to each other to open and close the mold. The inner cavity of the mold therefore has three dimensions, i.e. a length, a width and a depth. The mold can have a single cavity or multiple cavities. In multiple cavity molds, each cavity can be identical and form the same geometry or can be unique and form multiple different geometries.

The term “inner surface (SU)” refers in accordance with the invention to the surface of the mold parts that comes into contact with the coating composition (C1) and the non-crosslinkable polymer composition (C2) and, optionally, further materials and compositions used in the process, during the production of the molded material. The inner surface (SU) is therefore facing the mold cavity which is formed when closing the mold parts.

“Drying” of the applied coating composition (C1) refers to the evaporation of solvents from the applied coating composition (C1). Drying can be performed at ambient temperature or by use of elevated temperatures. However, the drying does not result in a coating film being ready for use, i.e. a cured coating film as described below, because the coating film is still soft or tacky after drying. Accordingly, “curing” of a coating film refers to the conversion of such a film into the ready-to-use state, i.e. into a state in which the non-crosslinked polymer material provided with the respective coating film can be transported, stored and used as intended. More particularly, a cured coating film is no longer soft or tacky, but has been conditioned as a solid coating film which does not undergo any further significant change in its properties, such as hardness or adhesion to the substrate, even under further exposure to curing conditions. Curing can be performed at higher temperatures and/or for longer times than used for drying of the coating composition (C1).

“Binder” in the context of the present invention and in accordance with DIN EN ISO 4618:2007-03 is the nonvolatile component of a coating composition, without pigments and fillers. Hereinafter, however, the expression is used principally in relation to particular physically and/or chemically curable polymers, examples being polyurethanes, polyesters, polyethers, polyureas, polyacrylates, polysiloxanes and/or copolymers of the stated polymers. The nonvolatile fraction may be determined according to DIN EN ISO 3251:2018-07 at 130° C. for 60 min using a starting weight of 1.0 g.

The measurement methods to be employed in the context of the present invention for determining certain characteristic variables can be found in the Examples section. Unless explicitly indicated otherwise, these measurement methods are to be employed for determining the respective characteristic variable. Where reference is made in the context of the present invention to an official standard without any indication of the official period of validity, the reference is implicitly to that version of the standard that is valid on the filing date, or, in the absence of any valid version at that point in time, to the last valid version.

All film thicknesses reported in the context of the present invention should be understood as dry film thicknesses. It is therefore the thickness of the cured film in each case. Hence, where it is reported that a coating material is applied at a particular film thickness, this means that the coating material is applied in such a way as to result in the stated film thickness after curing.

All temperatures elucidated in the context of the present invention should be understood as the temperature of the room in which the substrate or the coated substrate is located. It does not mean, therefore, that the substrate itself is required to have the temperature in question.

### Inventive Process:

In the context of the method of the invention, a molded non-crosslinked polymer material comprising at least one at least partially coated surface is produced. In accordance with the invention, the coating of at least a part of at least one surface of the non-crosslinked polymer material is achieved by applying a coating composition (C1) in step (b) on the at least one inner surface (SU) of at least one mold part prior to injecting or introducing a non-crosslinkable polymer composition (C2) into the mold (MO) in step (d).

The process according to the invention can either be a manual process or an automatic process. A manual process in the context of the present invention is a process where each process step is not linked to strict cycle times. Accordingly, in a manual process, a significant variation in the cycle time of each process step during multiple repetitions of the process is present. However, the term “manual process” in the sense of the present invention does not mean that such processes cannot include automated process steps, an example being the use of robots. In contrast, an automatic process within the sense of the present invention is a process in which the individual process steps are linked to strict cycle times, in other words where, on multiple repetitions of the process, the cycle time for a process step is identical or does not vary significantly.

### Step (a):

In step (a) of the inventive process, a closable, three dimensional mold (MO) having at least two mold parts which are movable relative to each other and which form a mold cavity is provided. In the context of the invention, the mold (MO) can also be formed of more than two mold parts, for example from three to ten mold parts.

The closable, three dimensional mold (MO) having at least two mold parts can be a metallic mold, a polymeric mold or a mold comprising metallic and polymeric mold parts. In this respect, the mold parts are preferably selected from metallic mold parts, preferably aluminum, steel, nickel or copper mold parts, very preferably aluminum and/or steel mold parts, and/or from polymeric mold parts, preferably polyamide mold parts.

### Step (b):

In step (b) of the inventive process, a coating composition (C1) is applied on at least a part of the at least one inner surface (SU) facing the mold cavity of the closable, three dimensional mold (MO) and the applied composition (C1) is dried. The coating composition (C1) is therefore present on at least part of the surface of the mold parts which come in contact with the non-crosslinkable polymer composition (C2) injected or introduced into the mold in step (d) of the inventive process.

The coating composition (C1) is used as release and coating agent, thus allowing to obtain a coated non-crosslinked polymer material while at the same time facilitating demolding of the coated material in step (f) of the inventive process. The coating of the non-crosslinked polymer material during its production renders post-coating processes superfluous. Moreover, the incorporation of a release agent into the coating composition allows to avoid the use of external release agents which hamper the adhesion of coating layers to the non-crosslinked polymer material and therefore require additional cleaning steps before a coating layer can be applied. In order to facilitate demolding of the non-crosslinked polymer material without damage and coating of said material on all surfaces, said coating composition (C1) is preferably applied on all inner surfaces of the mold parts facing the mold cavity. However, it is likewise possible to only coat specific areas of the inner surface (SU) or to only coat one of several inner surfaces (SU) of the mold parts with the coating composition (C1). It is likewise also possible to apply several coating compositions (C1) having different colors on different inner surfaces (SU) of the mold to achieve a coating on the non-crosslinked polymer material having different colors. In this case, masking may be used to prevent undesired overspray.

The coating composition (C1) preferably possesses a solids content of 30 to 60 wt. %, more preferably of 35 to 55 wt. %, very preferably of 40 to 50 wt. %, more particularly of 42 to 48 wt. %, based on the total weight of the coating composition (C1). The solids content was determined according to ASTM D2369 (2015) at 110° C. for 60 min on a 2 gram sample of the composition.

It is preferred in accordance with the invention, if the coating composition (C1) has a viscosity of 10 to 60 s, more particularly of 20 to 30 s (DIN4 flow cup), measured according to DIN EN ISO 2431 (March 2012). Establishing a low viscosity facilitates the application of the coating composition (C1) and therefore ensures sufficient wetting of the molding tool and a uniform coating of the non-crosslinked polymer composition (C2).

The coating composition (C1) used in step (b) comprises
(i) at least one solvent L,
(ii) at least one compound of the general formula (I)

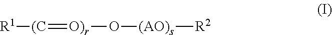

in which R¹ is a saturated or unsaturated aliphatic hydrocarbon radical having 6 to 30 carbon atoms,
R² is H,
AO stands for one or more alkylene oxide radicals selected from the group consisting of ethylene oxide, propylene oxide and butylene oxide,
r is 0 or 1, and
s is 0 to 30;
(iii) at least one polysiloxane of the general formula (II)

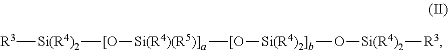

in which
R³ and R⁴, in each case independently of one another, are a methyl group or a (HO—CH₂)₂—C(CH₂—CH₃)—CH₂—O—(CH₂)₃—* radical,
R⁵ is a methyl group,
a is 0 or 1 to 10, and
b is 3 to 30; and
(iv) at least one binder,
(v) at least one crosslinking agent and
(vi) optionally at least one polyether-modified alkylpolysiloxane.

### Solvent L:

The coating composition (C1) comprises at least one solvent L and is therefore preferably a liquid coating composition. The coating composition (C1) may be a solvent-based coating composition or an aqueous coating composition. In the case of a solvent-based coating composition, organic solvents are included as a principal constituent. Organic solvents constitute volatile constituents of the composition of the invention, and undergo complete or partial vaporization on drying or flashing, respectively. The principal constituent of aqueous coating compositions is water.

Suitable solvents L include organic solvents, water, and mixtures thereof. The at least one solvent L is preferably present in a total amount of 40 to 70 wt. %, more preferably 45 to 65 wt. %, and very preferably 50 to 60 wt. %, especially 52 to 58 wt. %, based in each case on the total weight of the coating composition (C1).

Organic solvents preferred in the context of the present invention are aprotic. With particular preference they are polar aprotic organic solvents. With very particular preference the organic solvents are chemically inert toward the remaining constituents of the composition.

Preferred organic solvents in the context of the present invention are, for example, ketones such as acetone, methyl ethyl ketone, cyclohexanone, methyl isobutyl ketone, methyl isoamyl ketone or diisobutyl ketone; esters such as ethyl acetate, n-butyl acetate, ethylene glycol diacetate, butyrolactone, diethyl carbonate, propylene-carbonate, ethylene carbonate, 2-methoxypropyl acetate (MPA), and ethyl ethoxypropionate; amides such as N,N-dimethylformamide, N, N-dimethylacetamide, N-methylpyrrolidone, and N-ethylpyrrolidone; methylal, butylal, 1,3-dioxolane, glycerol formal; and, somewhat less preferably because they are nonpolar, hydrocarbons such as benzene, toluene, n-hexane, cyclohexane, and solvent naphtha. Especially preferred solvents belong to the class of the esters, among which n-butyl acetate and 1-methoxypropyl acetate are very especially preferred.

### Compound of General Formula (I):

The coating composition (C1) comprises, as a second essential constituent, at least one compound of general formula (I):

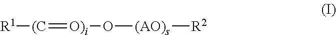

in which
R¹ is a saturated or unsaturated, aliphatic hydrocarbon radical having 6 to 30 carbon atoms,
R² is H,
AO stands for one or more alkylene oxide radicals selected from the group consisting of ethylene oxide, propylene oxide and butylene oxide,
r is 0 or 1, and
s is 0 to 30.

The radical R¹ is preferably an acyclic residue and is more preferably a saturated or unsaturated aliphatic hydrocarbon radical having 10 to 24 carbon atoms.

The radicals AO may be identical or different and within the s radicals may have a random, blockwise or gradient-like arrangement.

Where at least two different kinds of AO radicals are present, it is preferred if the fraction of ethylene oxide is more than 50 mol %, more preferably at least 70 mol %, and very preferably at least 90 mol %, based on the total molar amount of the radicals AO. In the aforementioned cases the radicals different from ethylene oxide are preferably propylene oxide radicals.

If r=0 and s>0, the compounds of the formula (I) are alkoxylated fatty alcohols, preferably ethoxylated fatty alcohols, while the compounds of formula (I) are alkoxylated fatty acids, if r=1 and s>0, preferably ethoxylated fatty acids.

With particular preference, for some or all the compounds of general formula (I), s is 2 to 25, m or preferably 6 to 20.

In particularly preferred compounds of general formula (I), residue R¹ is a saturated or unsaturated aliphatic hydrocarbon radical having 10 to 24 carbon atoms, AO stands for one or more alkylene oxide radicals selected from the group consisting of ethylene oxide and propylene oxide, r is 0 or 1, and s is 0 or 2 to 25, preferably 6 to 20.

In further particularly preferred compounds of general formula (I), residue R¹ is a saturated or unsaturated aliphatic hydrocarbon radical having 10 to 24 carbon atoms, AO stands for one or more alkylene oxide radicals selected from the group consisting of ethylene oxide and propylene oxide and the ethylene oxide fraction in the total molar amount of the radicals AO is at least 70 mol %, r=0 or 1, and s=0 or s=6 to 20.

In particular it is also possible to use mixtures of compounds of general formula (I) in which s is 0 for at least one compound while for at least one further compound s is >0, preferably 2 to 25, more preferably 6 to 20. It is also possible to use a mixture of compounds of formula (I) in which r is 0 for at least one compound while for at least one further compound, r is 1. A suitable mixture of compounds of general formula (I) includes at least one compound of formula (Ia)

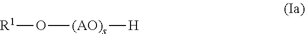

and at least one compound of formula (Ib)

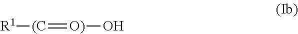

in which
R¹ is a saturated or unsaturated, aliphatic hydrocarbon radical having 6 to 30 carbon atoms, preferably a saturated or unsaturated, aliphatic hydrocarbon radical having 12 to 22 carbon atoms,
R¹′ is a saturated or unsaturated, aliphatic hydrocarbon radical having 6 to 30 carbon atoms, preferably an unsaturated, aliphatic hydrocarbon radical having 21 carbon atoms,
AO stands for one or more alkylene oxide radicals selected from the group consisting of ethylene oxide, propylene oxide and butylene oxide, preferably ethylene oxide, and
S is 2 to 28, preferably 6 to 20.

The aforementioned mixture of compounds of formula (Ia) and (Ib) results in a good demolding of the coated non-crosslinked polymer material without negatively influencing the high adhesion of the coating layer formed from coating composition (C1) to the non-crosslinked polymer material.

The total weight of the compound of the general formula (I) is preferably 0.1 to 10 wt. %, more preferably 0.5 to 5 wt. %, more particularly 1.5 to 4 wt. % based in each case on the total weight of the coating composition (C1). Where more than one compound of general formula (I) is used, the amounts indicated above are based on the total amount of all compounds which fall within general formula (I).

### Polysiloxane of Formula (II):

The coating composition (C1) further comprises at least one polysiloxane of general formula (II)

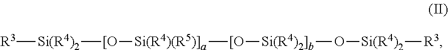

in which
R³ and R⁴, in each case independently of one another, are a methyl group or a (HO—CH₂)₂—C(CH₂—CH₃)—CH₂—O—(CH₂)₃—* radical,
R⁵ is a methyl group,
a is 0 or 1 to 10, and
b is 3 to 30.

The *-symbol denotes the linking of the (HO—CH₂)₂—C(CH₂—CH₃)—CH₂—O—(CH₂)₃-radical to the silicon atom, i.e. the (HO—CH₂)₂—C(CH₂—CH₃)—CH₂—O—(CH₂)₃— is bonded via the *-symbol to the silicon atom.

Used with preference in accordance with the invention are polysiloxanes which have particular radicals R³ and R⁴. The use of such polysiloxanes has proven advantageous in relation to the improved demoldability without adversely affecting the adhesion of the coating layer formed form the coating composition (C1) to the non-crosslinked polymer material. In one preferred embodiment, the radical R³ in general formula (II) is a (HO—CH₂)₂—C(CH₂—CH₃)—CH₂—O—(CH₂)₃—* radical and the radicals R⁴ and R⁵ are each a methyl group.

With preference, a in general formula (II) is 0, and b is 7 to 14.

Suitable total amounts of the at least one polysiloxane of general formula (II) include 0.1 to 5 wt. %, preferably 0.5 to 4 wt. %, more particularly 0.8 to 2.5 wt. %, based in each case on the total weight of the coating composition (C1). If more than one polysiloxane of general formula (II) is present, then the amounts indicated above are based on the total amount of all the polysiloxanes which fall within general formula (II).

### Binder:

The coating composition (C1) is a film forming composition and thus comprises at least one binder.

Surprisingly, an excellent demolding as well as an excellent quality of the cured coating layer, especially an excellent adhesion, recoatability and adhesive bonding, is achieved with cured coating compositions (C1) irrespective of the nature of the binder. The coating composition (C1) can therefore contain any crosslinkable binder, without adversely affecting the demoldability of the produced coated non-crosslinked polymer material or the outstanding properties of the coating layer produced from the coating composition (C1).

Suitable binders include (i) poly(meth)acrylates, more particularly hydroxy-functional and/or carboxylate-functional and/or amine-functional poly(meth)acrylates, (ii) polyurethanes, more particularly hydroxy-functional and/or carboxylate-functional and/or amine-functional polyurethanes, (iii) polyesters, more particularly polyester polyols, (iv) polyethers, more particularly polyether polyols, (v) copolymers in the stated polymers, and (vi) mixtures thereof.

Preferred binder(s) is/are selected from hydroxy-functional poly(meth)acrylates and/or polyester polyols, more particularly from a mixture of at least one hydroxy-functional poly(meth)acrylate and at least one polyester polyol. The use of this mixture leads to coatings which have a high flexibility and a high resistance toward environmental influences. Furthermore, the obtained coating layer can be adhesively bonded and/or coated with basecoat and/or clearcoat materials without costly and inconvenient aftertreatment.

The hydroxy-functional poly(meth)acrylate preferably possesses a hydroxyl number of 65 to 100 mg KOH/g, more preferably of 70 to 95 mg KOH/g, more particularly of 75 to 90 mg KOH/g or of 80 to 85 mg KOH/g. The hydroxyl number in the context of the present invention may be determined according to EN ISO 4629-2:2016 and is based in each case on the solids content.

The hydroxy-functional poly(meth)acrylate preferably possesses an acid number of less than 25 mg KOH/g, more preferably an acid number of 1 to 20 mg KOH/g, very preferably an acid number of 4 to 16 mg KOH/g, more particularly of 6 to 14 mg KOH/g or of 8 to 12 mg KOH/g. The acid number for the purposes of the present invention may be determined according to DIN EN ISO 2114:2002-06 (method A) and is based in each case on the solids content.

The number-average molecular weight Mₙ and the weight-average molecular weight M_{w} may be determined by means of gel permeation chromatography (GPC) using a polymethyl methacrylate standard (PMMA standard) (DIN 55672-1:2016-03). The number-average molecular weight Mₙ of the hydroxy-functional poly(meth)acrylate is preferably in a range from 4000 to 10 000 g/mol, more preferably 5000 to 9000 g/mol, very preferably 5500 to 8000 g/mol, more particularly 6000 to 7500 g/mol. The weight-average molecular weight M_{w} of the hydroxy-functional poly(meth)acrylate is preferably in a range from 8000 to 30 000 g/mol, more preferably 10 000 to 25 000 g/mol, very preferably 12 000 to 22 000 g/mol, more particularly 14 000 to 20 000 g/mol.

The polydispersity PD (=M_{w}/Mₙ) of the hydroxy-functional poly(meth)acrylate is preferably in the range from 2 to 3, more particularly from 2.2 to 2.8.

The hydroxy-functional poly(meth)acrylate preferably possesses a hydroxyl functionality of 5 to 15, more preferably of 6 to 14, more particularly of 8 to 12.

The hydroxy-functional poly(meth)acrylate may be obtained by means of the polymerization reactions that are commonplace and familiar to a person of ordinary skill in the art, from ethylenically unsaturated monomers, preferably monoethylenically unsaturated monomers. Initiators which may be used include peroxides, such as di-tert-butyl peroxide, for example. It is therefore preferred for the hydroxy-functional poly(meth)acrylate to be preparable by reaction of
(a1) at least one hydroxy-functional (meth)acrylic ester, more particularly (meth)acrylic ester of the formula HC═CR^{x}—COO—R^{y}—OH, in which Rx is H or CH₃ and R^{y} is an alkylene radical having 2 to 6, preferably 2 to 4, more preferably 2 or 3 carbon atoms,
(a2) at least one carboxy-functional ethylenically unsaturated monomer, more particularly (meth)acrylic acid, and
(a3) at least one hydroxyl-free and carboxyl-free ester of (meth)acrylic acid and/or at least one hydroxyl-free and carboxyl-free vinyl monomer, more particularly styrene.

Examples of hydroxy-functional (meth)acrylic esters (a1) are preferably hydroxyethyl methacrylate, hydroxyethyl acrylate, hydroxypropyl methacrylate, and hydroxypropyl acrylate, and with particular preference hydroxyethyl methacrylate and 2-hydroxypropyl methacrylate. The amount of hydroxy-functional (meth)acrylic esters (a1) used in preparing the hydroxy-functional poly(meth)acrylate is calculated on the basis of the target range for the hydroxyl number, of 50 to 120 mg KOH/g.

The hydroxy-functional poly(meth)acrylate preferably contains small quantities of carboxyl groups. These groups are introduced into the poly(meth)acrylate during the polymerization reaction, through the use, for example, of carboxy-functional monomers (a2), more preferably through the use of acrylic acid and/or methacrylic acid. These monomers (a2), especially (meth)acrylic acid, are present preferably in a total amount of 20 to 45 wt. %, more preferably of 25 to 40 wt. %, more particularly of 30 to 35 wt. %, based in each case on the total weight of all the monomers used in preparing the hydroxy-functional poly(meth)acrylate.

Besides the hydroxy-functional (a1) and the carboxy-functional (a2) ethylenically unsaturated monomers, use is also made when preparing the hydroxy-functional poly(meth)acrylate of ethylenically unsaturated monomers (a3), more particularly monoethylenically unsaturated monomers (a3), these monomers being free both of hydroxyl and of carboxyl groups. Employed with particular preference as vinyl monomer (a3) is styrene. The vinyl monomer (a3), more particularly styrene, is present preferably in a total amount of 30 to 60 wt. %, more preferably of 35 to 55 wt. %, more particularly of 40 to 50 wt. %, based in each case on the total weight of all the monomers used in preparing the hydroxy-functional poly(meth)acrylate.

The hydroxy-functional poly(meth)acrylate may be used in an organic solvent, preferably an aprotic solvent. A typical solvent for this purpose, for example, is n-butyl acetate, which may also be used when preparing the at least one hydroxy-functional poly(meth)acrylate. If the hydroxy-functional poly(meth)acrylate is used in a solvent, then the solvent is regarded as part of the solvent L.

The hydroxy-functional poly(meth)acrylate is preferably used in a particular total amount. It is therefore advantageous in accordance with the invention if the hydroxy-functional poly(meth)acrylate is present in a total amount of 10 to 97 wt. %, preferably of 40 to 70 wt. %, more particularly of 40 to 50 wt. %, based in each case on the total weight of the solids content of all the binders present in the composition.

The polyester polyol preferably possesses a hydroxyl number of 100 to 200 mg KOH/g, more preferably of 110 to 180 mg KOH/g, very preferably of 120 to 160 mg KOH/g, based in each case on the solids content.

The acid number of the polyester polyol is preferably 0 to 9 mg KOH/g, more particularly 0.2 to 2 mg KOH/g, based in each case on the solids content. The hydroxyl number and acid number of the polyester polyol may be determined as above in conjunction with the hydroxy-functional poly(meth)acrylate.

The number-average molecular weight of the polyester polyol is preferably in the range from 800 to 3,000 g/mol, more preferably 1,000 to 2,000 g/mol, more particularly from 1,000 to 1,600 g/mol. The determination here is made as in connection with the determination of the molecular weight of the hydroxy-functional poly(meth)acrylate.

The polyester polyol is preferably branched.

The polyester polyol preferably possesses a hydroxyl functionality of 2.2 to 4, more preferably of 2.5 to 3.5, very preferably of 2.7 to 3.3.

The polyester polyol is preferably used in a particular total amount. It is therefore advantageous in accordance with the invention if the polyester polyol is present in a total amount of 40 wt. % to 97 wt. %, preferably of 40 to 70 wt. %, more particularly of 50 to 65 wt. %, based in each case on the total weight of the solids content of all the binders present in the composition.

The binder B may alternatively be selected from aqueous, anionically stabilized polyurethane dispersions, aqueous, cationically stabilized polyurethane dispersions, aqueous polyurethane-polyurea dispersions, and mixtures thereof. Suitable dispersions are described, for example, in the laid-open specifications EP 2 066 712 A1, EP 1 153 054 A1, and EP 1 153 052 A1.

The at least one binder is present preferably in a total amount (solids content) of 20 to 50 wt. %, more preferably of 25 to 40 wt. %, more particularly 25 to 35 wt. %, based in each case on the total weight of the coating composition (C1). If the binder is a dispersion or solution in a solvent, the above-recited total amounts are calculated using the solids content of the binder in each case. The use of the at least one binder in the above-recited amounts ensures the formation of a flexible and stable coating layer on the non-crosslinked polymer material without negatively affecting the excellent demoldability of the coated non-crosslinked polymer material.

### Crosslinking Agent

The coating composition (C1) further comprises at least one crosslinking agent. Said crosslinking agent comprises at least one reactive functional group which is able to undergo crosslinking reactions with complementary reactive functional groups present in the at least one binder. Since the at least one binder preferably contains reactive functional groups in the form of hydroxyl groups, preferred reactive functional groups which are able to undergo crosslinking reactions with such hydroxyl groups are isocyanate groups, amino groups or carbodiimide groups.

The at least one crosslinking agent is preferably selected from amino resins, unblocked polyisocyanates, blocked polyisocyanates, polycarbodiimides, photoinitators and mixtures thereof. Particularly preferred crosslinking agents are polyisocyanates.

Particular preference is given to using unblocked polyisocyanates, i.e. compounds containing at least two free isocyanate groups.

In this context, it is particularly preferred if the polyisocyanate has an NCO content of 10 to 50% by weight, preferably 15 to 40% by weight, very preferably 20 to 25% by weight or 28 to 35% by weight, as determined according to DIN EN ISO 11909:2007-05 or ASTM D 5155-2014.

The polyisocyanate preferably comprises oligomers, preferably trimers or tetramers, of diisocyanates. With particular preference it comprises iminooxadiazinediones, isocyanurates, allophanates and/or biurets of diisocyanates. With particular preference the polyisocyanate comprises aliphatic and/or cycloaliphatic, very preferably aliphatic, polyisocyanates. Serving as a diisocyanate basis for the aforementioned oligomers, more particularly the aforementioned trimers or tetramers, is very preferably hexamethylene diisocyanate and/or isophorone diisocyanate and/or methylene diphenyl diisocyanate, and especially preferably hexamethylene diisocyanate and/or methylene diphenyl diisocyanate.

The use of polycarbodiimides has been found appropriate especially when aqueous, anionically stabilized polyurethane dispersions, aqueous, cationically stabilized polyurethane dispersions, aqueous polyurethane-polyurea dispersions, and mixtures thereof are present as binders B in the composition of the invention.

The polycarbodiimides are preferably in the form of an aqueous dispersion. Polycarbodiimides used with particular preference are obtainable by reaction of polyisocyanates with polycarbodiimides and subsequent chain extension and/or termination by means of hydrophilic compounds containing hydroxyl groups and/or amine groups. Suitable dispersions are described in the laid-open specifications EP1644428 A2 and EP1981922 A2, for example.

Employed with particular preference as crosslinking agents are polyisocyanates which comprise at least one isocyanurate ring or at least one iminooxadiazinedione ring.

The hardness, flexibility, and elasticity of the resulting cured coating layer can be influenced by selecting an appropriate crosslinking agent. Use of polyisocyanates containing iminooxadiazinedione structures leads to coating layers having a high hardness, thereby preventing structures of the non-crosslinked polymer materials from propagating through the surface of the cured coating layer, thus causing waviness. Such polyisocyanates are available for example from Covestro under the name Desmodur® N3900. Similar results may be achieved with polyisocyanates containing isocyanurate structures, as available for example under the name Desmodur N3800 from Covestro, in which case the coating layers are more flexible than coating layers obtained when using polyisocyanates containing iminooxadiazinedione structures.

The coating composition (C1) preferably comprises the at least one crosslinking agent, preferably polyisocyanates, in a total amount of 10 wt. % to 40 wt. %, preferably of 10 to 30 wt. %, more particularly of 15 to 25 wt. %, based in each case on the total weight of the coating composition (C1). In case a mixture of different crosslinking agents is used, the afore-stated amounts refer to the sum of all crosslinking agents present in the coating composition (C1).

It is preferred, furthermore, if the coating composition comprises a particular molar ratio of the functional groups of the crosslinking agent to the sum of the complementary reactive functional groups present groups in the at least one binder. This ensures a sufficient crosslinking of the coating composition under curing conditions. It is therefore advantageous if the molar ratio of the functional groups of the crosslinking agent, more particularly of the NCO groups of the polyisocyanates, to the sum of the complementary reactive functional groups present groups in the at least one binder, more particularly hydroxyl groups, is 0.4:1 to 1:1, preferably 0.65:1 to 0.85:1, very preferably 0.7:1 to 0.8:1.

### Polyether-Modified Alkylpolysiloxane:

The coating composition (C1) may further comprise at least one polyether-modified alkylpolysiloxane. The term “polyether-modified alkylpolysiloxane” in accordance with the invention denotes an alkylpolysiloxane which is modified with at least one polyether group at the terminal ends and/or in the main chain. The polyether group(s) may be bonded directly and/or via an alkyl group to the silicon atom of the alkylpolysiloxane. The polyether group(s) are preferably bonded directly to the silicon atom of the alkylpolysiloxane. Preferred polyether group(s) include ethylene oxide, propylene oxide and butylene oxide groups.

The use of such polyether-modified alkylpolysiloxane leads to reduced staining of the cured coating layer by environmental influences, such as dirt.

Preferably, the polyether-modified alkylpolysiloxane comprises at least one structural unit (R⁷)₂(OR⁶)SiO_{1/2} and at least one structural unit (R⁷)₂SiO_{2/2}, where R⁶ is an ethylene oxide, propylene oxide, and butylene oxide group, more particularly a mixture of ethylene oxide and propylene oxide and butylene oxide groups, and R⁷ is a C1-C10 alkyl group, more particularly a methyl group.

It is preferred in this context if the polyether-modified alkylpolysiloxane has a molar ratio of siloxane to ethylene oxide groups to propylene oxide groups to butylene oxide groups of 6:21:15:1 to 67:22:16:1.

It is preferred in this context, furthermore, if the polyether-modified alkylpolysiloxane has a molar ratio of the structural unit (R⁶)₂(OR⁷)SiO_{1/2} to the structural unit (R⁷)₂SiO_{2/2} of 1:10 to 1:15, more particularly of 1:10 to 1:13. R⁶ and R⁷ have the definitions listed above.

The at least one polyether-modified alkylpolysiloxane preferably has a refractive index of 1.4 to 1.6, more preferably of 1.42 to 1.46, as determined according to DIN 51423-2:2010-02 at 23° C. Due to the high refractive index, said polyether-modified alkylpolysiloxane is transparent and can therefore be used in coating compositions C1) which should result in transparent cured coating layers.

The at least one polyether-modified alkylpolysiloxane preferably has a viscosity of 300 to 1,500 mPa*s, more preferably 400 to 1,000 mPa*s, very preferably 500 to 900 mPa*s, as determined according to DIN 53015:2001-02 at 23° C.

Suitable alkylpolysiloxanes are, for example, commercially available under the tradename Silmer® OHT Di-10, Silmer® OHT Di-50 or Silmer® OHT Di-100 from Siltech Corporation.

The coating composition (C1) may comprise 0 to 6% by weight, preferably 0.5 to 4% by weight, very preferably 0.8 to 3% by weight, based in each case on the total weight of the coating composition (C1), of polyether-modified alkylpolysiloxanes, more particularly of the specific polyether-modified alkylpolysiloxanes listed above. The absence of such compounds can reduce the tackiness of the coating composition (C1) and might therefore improve the demolding properties achieved with the cured coating composition (C1).

### Crosslinking Catalyst:

The coating composition (C1) may further comprise at least one crosslinking catalyst. The crosslinking catalyst serves primarily to catalyze the reaction between the functional groups of the crosslinking agent and the groups of the at least one binder that are reactive toward the functional groups of the crosslinking agent.

The crosslinking catalyst is preferably selected from the group of the bismuth carboxylates. Suitable bismuth carboxylates include bismuth carboxylates of general formula (III)

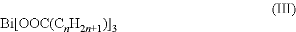

where n=5 to 15, preferably n=7 to 13, more particularly n=9 to 11.

The carboxylate radicals are preferably branched, and very preferably they have a tertiary or quaternary, preferably quaternary, carbon atom in the alpha-position to the carbon atom of the carboxylate group. Among the bismuth carboxylates, bismuth trineodecanoate in particular has emerged as being especially suitable.

The bismuth carboxylates are preferably used in stabilized form in combination with the parent carboxylic acid of the carboxylate, HOOC(CₙH₂ₙ₊₁), in which n possesses the definition indicated above. The free carboxylic acid is, for the purposes of this invention, regarded as an additive.

The coating composition (C1) preferably comprises the at least one crosslinking catalyst in a particular total amount. It is therefore preferred in accordance with the invention if the at least one crosslinking catalyst is present in a total amount of 0.01 wt. % to 3.5 wt. %, preferably of 0.1 to 2 wt. %, more particularly of 0.4 to 1.5 wt. %, based in each case on the total weight of the coating composition (C1).

### Pigments/Fillers:

The coating composition (C1) may further comprise at least one pigment and/or at least one filler. Suitable pigments are, for example, all organic and inorganic coloring pigments, effect pigments and mixtures thereof commonly used in aqueous and solvent-based coating composition. Such color pigments and effect pigments are known to those skilled in the art and are described, for example, in Römpp-Lexikon Lacke und Druckfarben, Georg Thieme Verlag, Stuttgart, New York, 1998, pages 176 and 451. The terms “coloring pigment” and “color pigment” are interchangeable, just like the terms “visual effect pigment” and “effect pigment”.

The use of pigments and/or fillers is advantageous if colored coating layers should be obtained. The presence of pigments and/or fillers in the coating composition (C1) does not negatively influence the demoldability, the adhesion and the recoatability of the obtained cured coating layers. Accordingly, it is possible to obtain a cured coating layer already having the desired color directly after production of the non-crosslinked polymer material, so that there is no need for the application of further coating layers to adjust the color of the non-crosslinked polymer material.

Examples of inorganic coloring pigments include (i) white pigments, such as titanium dioxide, zinc white, colored zinc oxide, zinc sulfide, lithopone; (ii) black pigments, such as iron oxide black, iron manganese black, spinel black, carbon black; (iii) color pigments, such as ultramarine green, ultramarine blue, manganese blue, ultramarine violet, manganese violet, iron oxide red, molybdate red, ultramarine red, iron oxide brown, mixed brown, spinel and corundum phases, iron oxide yellow, bismuth vanadate; (iv) filer pigments, such as silicon dioxide, quartz flour, aluminum oxide, aluminum hydroxide, natural mica, natural and precipitated chalk, barium sulphate and (vi) mixtures thereof.

Suitable organic coloring pigments are selected from (i) monoazo pigments such as C.I. Pigment Brown 25, C.I. Pigment Orange 5, 36 and 67, C.I. Pigment Orange 5, 36 and 67, C.I. Pigment Red 3, 48:2, 48:3, 48:4, 52:2, 63, 112 and 170 and C.I. Pigment Yellow 3, 74, 151 and 183; (ii) diazo pigments such as C.I. Pigment Red 144, 166, 214 and 242, C.I. Pigment Red 144, 166, 214 and 242 and C.I. Pigment Yellow 83; (iii) anthraquinone pigments such as C.I. Pigment Yellow 147 and 177 and C.I. Pigment Violet 31; (iv) benzimidazole pigments such as C.I. Pigment Orange 64; (v) quinacridone pigments such as C.I. Pigment Orange 48 and 49, C.I. Pigment Red 122, 202 and 206 and C.I. Pigment Violet 19; (vi) quinophthalone pigments such as C.I. Pigment Yellow 138; (vii) diketopyrrolopyrrole pigments such as C.I. Pigment Orange 71 and 73 and C.I. Pigment Red, 254, 255, 264 and 270; (viii) dioxazine pigments such as C.I. Pigment Violet 23 and 37; (ix) indanthrone pigments such as C.I. Pigment Blue 60; (x) isoindoline pigments such as C.I. Pigment Yellow 139 and 185; (xi) isoindolinone pigments such as C.I. Pigment Orange 61 and C.I. Pigment Yellow 109 and 110; (xii) metal complex pigments such as C.I. Pigment Yellow 153; (xiii) perinone pigments such as C.I. Pigment Orange 43; (xiv) perylene pigments such as C.I. Pigment Black 32, C.I. Pigment Red 149, 178 and 179 and C.I. Pigment Violet 29; (xv) phthalocyanine pigments such as C.I. Pigment Violet 29, C.I. Pigment Blue 15, 15:1, 15:2, 15:3, 15:4, 15:6 and 16 and C.I. Pigment Green 7 and 36; (xvi) aniline black such as C.I. Pigment Black 1; (xvii) azomethine pigments; and (xviii) mixtures thereof.

Examples of effect pigments include (i) plate-like metallic effect pigments such as plate-like aluminum pigments, gold bronzes, fire-colored bronzes, iron oxide-aluminum pigments; (ii) pearlescent pigments, such as metal oxide mica pigments; (iii) plate-like graphite pigments; (iv) plate-like iron oxide pigments; (v) multi-layer effect pigments from PVD films; (vi) liquid crystal polymer pigments; and (vii) mixtures thereof.

The at least one pigment and/or the at least one filler is preferably present in a total amount of 0.1 wt. % to 10 wt. %, based on the total weight of the coating composition (C1).

### Additives:

The coating composition (C1) may further comprise at least an additive selected from the group consisting of wetting agents and/or dispersants, rheological assistants, flow control agents, UV absorbers, and mixtures thereof.

The at least one additive is preferably present in a total amount of 0.1 wt. % to 10 wt. %, based on the total weight of the coating composition (C1).

### Preparation of the Coating Composition (C1):

Depending on the particular binders and crosslinkers present in the coating composition (C1), said composition is configured as a one-component system or is obtainable by mixing at least two (multicomponent system) components. Preferably, the coating composition (C1) is configured as a multicomponent system comprising at least two separate components, i.e. the at least one binder and the at least one crosslinker are reactive towards each other and must therefore be stored separately from each other prior to application to avoid an undesired premature reaction. Generally, the binder component and the crosslinker component may only be mixed together shortly before application. The term “shortly before application” is well known to the person skilled in the art. The time period within which the ready-to-use coating composition may be prepared by mixing the components prior to the actual application depends on the pot life of the coating application.

Thus, a preferred multicomponent system (i.e. a kit-of-parts) for the preparation of the coating composition (C1) comprises
A) at least one base varnish component comprising the at least one solvent L, the at least one compound of general formula (I), the at least one binder and the polysiloxanes of general formula (II); and
B) at least one hardener component comprising the at least one crosslinking agent. With respect to the ingredients of base varnish component A) and hardener component B), reference is made to the previously described coating composition (C1).

As previously described, components A) and B) of the kit-of-parts are stored separately and only combined shortly before application.

The at least one base varnish may further comprise at least one polyether-modified alkylpolysiloxane and/or at least one pigment and/or filler and/or at least one additive.

The kit-of-parts can also comprise further components, for example a dilution component C) comprising at least one solvent and optionally at least one rheological assistant to modify the viscosity of the inventive coating composition. The at least one solvent can be identical or different from the solvent L in the base varnish. If a different solvent is used, said solvent is preferably compatible with the solvent L in the base varnish in order to prevent undesired phase separation, agglomeration or precipitation upon mixing. With particular preference, the solvent is identical to the solvent L in the base varnish.

The components A) and B) are preferably mixed in a weight ratio of 100:10 to 100:100, more preferably from 100:20 to 100:80, more particularly from 100:50 to 100:70. The use of the above-described mixing ratios ensures sufficient crosslinking of the coating composition (C1) prepared from the kit-of-parts, resulting in a high adhesion as well as an excellent demoldability.

Mixing may take place manually, with the appropriate amount of a first component A) being introduced into a vessel, admixed with the corresponding quantity of the second component B) and optionally further components. However, mixing of the two or more components can also be performed automatically by means of an automatic mixing system. Such an automatic mixing system can comprise a mixing unit, more particularly a static mixer, and also at least two devices for supplying the binder containing first component A) and the crosslinker containing second component B), more particularly gear pumps and/or pressure valves. The static mixer may be a commercially available helical mixer, which is installed into the material supply line about 50 to 100 cm ahead of the atomizer. Preferably 12 to 18 mixing elements (for each element 1 cm in length, diameter 6 to 8 mm) are used in order to obtain sufficient mixing of the two components. In order to prevent clogging of the material supply line, it is preferred if the mixing unit is programmed so that not only the helical mixer but also the downstream hose line and the atomizer are flushed with the first component every 7 to 17 minutes. Where the composition is applied by means of robots, this flushing operation takes place when the robot head is in a pre-defined position of rest. Depending on the length of the hose line, about 50 to 200 ml are discarded into a catch vessel. A preferred alternative to this procedure is the semi continuous conveying of mixed release agent composition. If composition is forced out regularly (every 7 to 17 minutes, likewise into a catch vessel), it is possible to reduce the quantity of discard material to a minimum (about 10 to 50 ml). Furthermore, provision may be made for the hose line from the mixer to the atomizer, and also the atomizer, to be flushed. This flushing operation is preferred in particular after prolonged downtime of the system or at the end of a shift, in order thus to ensure a long lifetime of the equipment and continuous quality of the composition.

Both in the case of manual mixing and in the case of the supply of the components for automatic mixing, the separate components preferably each possess temperatures of 15 to 70° C., more preferably 15 to 40° C., more particularly 20 to 30° C.

### Application of the Coating Composition (C1):

The coating composition (C1) can be applied using commonly known application gear for liquid coating compositions, for example spray guns, or by means of an application robot. In terms of economy, the use of application robots is preferred. The robots are programmed for the geometry of the mold parts and apply the coating composition (C1) pneumatically and autonomously to the inner surface of the mold parts.

Where the coating composition (C1) is applied by means of application robots, it is preferred in accordance with the invention if, during the application of the composition with deployment of application robots, nozzles are used that have a diameter of 0.05 to 1.5 mm, preferably of 0.08 to 1 mm, more particularly of 0.1 to 0.8 mm. The use of nozzles having the afore-described diameters ensures that the surface(s) of the mold cavity are wetted with the desired amount of the composition.

The mold cavity preferably has a surface temperature in step (b) of 20 to 100° C., preferably 40 to 80° C., very preferably 60 to 70° C. Thus, the mold (MO) is preferably pre-heated before the application of the coating composition (C1) in step (b). Heating of the mold can be performed by supplying heat or by irradiation, for example IR radiation. Preferably the mold and/or the mold cavity is heated by means of IR radiation. In case the mold is preheated, said mold can be open or closed during the preheating. In case the mold is closed during preheating, the mold has to be opened before the coating composition (C1) can be applied.

### Drying of the Applied Coating Composition (C1):

After application of the coating composition (C1), a film is formed from the applied coating composition by drying the applied coating composition. This means the active or passive evaporation of solvents present in the coating composition (C1), usually at a temperature which is higher than the ambient temperature, for example at 40 to 140° C. The coating composition (C1) is still flowable directly after application and at the start of the flashing off and can therefore form a uniform, smooth coating film during the drying. The layer obtained from the coating composition after flashing, however, is not yet in the ready-to-use state. While it is indeed, for example, no longer fluid, it is still soft or tacky, and may have undergone only partial drying. In particular, the layer obtained from drying the coating composition (C1) is not yet crosslinked, as described below.

The drying time is preferably 20 seconds to 60 minutes, preferably of 20 seconds to 25 minutes. In this case it is advantageous if the molding tool possesses a temperature of 20 to 100° C., more preferably of 20 to 70° C.

The dry film thickness of the dried coating composition (C1) is preferably 20 to 120 μm, more preferably 25 to 100 μm.

### Step (c):

In optional step (c), at least one material (M1) is inserted into the mold (MO) and the mold (MO) is heated in order to activate the inserted material. With particular preference, the material (M1) inserted in process step (c) is an outsole, more particularly an outsole made of thermoplastic polyurethane. Thermoplastic polyurethanes may be prepared by reaction of high molecular mass polyols, such as polyester polyols and polyether polyols, having a number-average molecular weight of 500 to 10 000 g/mol, with diisocyanates and also low molecular mass diols (Mₙ 50 to 499 g/mol). It is also possible, however, to use outsoles made of other materials such as vulcanized or unvulcanized rubber and also mixtures of rubber and plastics.

Especially when using thermoplastic materials (M1), it is advantageous if the mold (MO) is heated in process step (c) to render the material (M1) deformable and to allow adaption of the material (M1) to the molding parts of the mold. It is therefore preferred if the mold (MO) is heated in process step (c) to 20 to 100° C., more preferably to 30 to 90° C., very preferably to 40 to 80° C., more particularly to 50 to 70° C. The mold (MO) can be heated by supplying heat or by irradiation, with IR radiation, for example. Preferably the mold (MO) is heated by means of IR radiation.

The mold (MO) may be closed after insertion of the at least one material (M1), heated, and subsequently opened again.

### Step (d):

According to a first alternative of step (d), the mold (MO) is closed and a non-crosslinkable polymer composition (C2) is injected. According to a second alternative of step (d), the non-crosslinkable polymer composition (C2) is introduced into the open mold (MO) and the mold is closed afterwards.

The non-crosslinkable polymer composition (C2) can be injected or introduced in a single step or in a plurality of steps. The latter may be preferred if the mold is divided into a plurality of fields. In that case the same or a different non-crosslinkable polymer composition (C2) may be injected in the plurality of steps. This technique is employed, for example, when the first field represents an outsole and the second field represents a self-contained sole frame. In this case, the non-crosslinkable polymer composition (C2) is injected first into the mold compartment for the sole and subsequently into the mold compartment of the self-contained sole frame.

Suitable non-crosslinkable polymer compositions (C2) include expanded thermoplastic polyurethane particles, expandable thermoplastic polyurethane particles, non-crosslinkable thermoplastic polyurethane, non-crosslinkable polyvinyl chloride, non-crosslinkable polycarbonate, non-crosslinkable polystyrene, non-crosslinkable polyethylene, non-crosslinkable polypropylene, non-crosslinkable acrylonitrile butadiene styrene, non-crosslinkable polyoxymethylene or non-crosslinkable polytetrafluoroethylene. With particular preference, expanded thermoplastic polyurethane particles or a non-crosslinkable thermoplastic polyurethane composition is used in step (d).

### Expanded and Expandable Thermoplastic Polyurethane Particles:

Expandable thermoplastic polyurethane particles contain a blowing agent and are expanded in a mold, with the particles increasing their volume and fusing with one another, to produce fused expanded polymer beads (also called thermoplastic bead foam). The expandable pellets may be formed, for example, by extrusion and subsequent pelletizing of a thermoplastic polyurethane polymer strand exiting an extruder. Pelletization is accomplished, for example, via appropriate chopping devices, operating under pressure and temperature conditions such that no expansion occurs. The expansion that then follows while fusing the pellets take place in general with the aid of steam at temperatures of 100 to 140° C.

Expanded thermoplastic polyurethane particles exhibit substantially increased bead sizes with correspondingly reduced densities as compared to expandable thermoplastic polyurethane particles. The production of beads with controlled prefoaming can be realized by appropriate process control, as described in WO 2013/153190 A1, for example. Hence, on exiting the extruder, extruded thermoplastic polyurethane polymer strands may be passed into a pelletizing chamber with a stream of liquid, the liquid being under specific pressure and having a specific temperature. Through adaptation of the operating parameters, it is possible to obtain specific expanded or preexpanded thermoplastic pellets, which can be converted into thermoplastic bead foam substrates by subsequent fusing and, optionally, further expansion with—in particular—steam.

Thermoplastic bead foams and corresponding thermoplastic, expandable and/or expanded pellets from which such bead foams may be produced are described in WO 2007/082838 A1, WO 2013/153190 A1 or else WO 2008/125250 A1, for example. Also described therein are operational parameters and starting materials for the production of thermoplastic polyurethanes, and also operational parameters for the production of pellets and bead foams.

Suitable expanded thermoplastic polyurethane particles have a bulk density of 5 g/l to 600 g/l. The average diameter of the expanded thermoplastic polyurethane particles may be from 0.2 mm to 20 mm, or from 0.5 mm to 15 mm, or from 1 mm to 12 mm. The average diameter of expandable thermoplastic polyurethane particles may be from 0.2 to 10 mm.

The expanded and/or the expandable thermoplastic polyurethane particles are preferably spherical.

With preference, the expanded and/or the expandable thermoplastic polyurethane particles are based on a polyether alcohol or a polyester alcohol. Thermoplastic polyurethanes (also called TPU hereinafter) and processes for their production are well known. TPUs used for production of preferred expanded or expandable TPU particles can be obtained via reaction of (a) isocyanates with (b) polyether alcohol or polyester alcohol, (c) chain extenders having a molar mass of from 50 to 499, if appropriate in the presence of (d) catalysts and/or of (e) conventional auxiliaries and/or conventional additives.

The starting components and processes for production of the preferred TPUs will be described by way of example below. Organic isocyanates (a) which may be used are well-known aliphatic, cycloaliphatic, araliphatic, and/or aromatic isocyanates, preferably diisocyanates, for example tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, and/or dicyclohexylmethane 4,4′-, 2,4′- and 2,2′-diisocyanate, diphenylmethane 2,2′-, 2,4′- and/or 4,4′-diisocyanate (MDI), naphthylene 1,5-diisocyanate (NDI), tolylene 2,4- and/or 2,6-diisocyanate (TDI), diphenylmethane diisocyanate, 3,3′-dimethylbiphenyl diisocyanate, 1,2-diphenylethane diisocyanate, and/or phenylene diisocyanate.

Compounds (b) are polyesterols and/or polyetherols, With preference, polyesterols and/or polyetherols having molar masses of from 500 to 8000, preferably from 600 to 6000, in particular from 800 to 4000, and preferably having an average functionality of from 1.8 to 2.3, preferably from 1.9 to 2.2, in particular 2 are used.

Chain extenders (c) that may be used comprise well-known aliphatic, araliphatic, aromatic and/or cycloaliphatic compounds having a molar mass of from 50 to 499, preferably difunctional compounds, such as diamines and/or alkanediols having from 2 to 10 carbon atoms in the alkylene radical, in particular 1,4-butanediol, 1,6-hexanediol, and/or di-, tri-, tetra-, penta-, hexa-, hepta-, octa-, nona- and/or decaalkylene glycols having from 3 to 8 carbon atoms, and preferably corresponding oligo- and/or polypropylene glycols, and use may also be made of a mixture of the chain extenders.

Suitable catalysts which in particular accelerate the reaction between the NCO groups of the diisocyanates (a) and the hydroxy groups of the structural components (b) and (c) are the conventional tertiary amines known from the prior art, e.g. triethylamine, dimethylcyclohexylamine, N-methylmorpholine, N,N′-dimethylpiperazine, 2-(dimethylaminoethoxy) ethanol, diazabicyclo-[2.2.2]octane and the like, and also in particular organometallic compounds, such as titanic esters, iron compounds, e.g. ferric acetylacetonate, tin compounds, e.g. stannous diacetate, stannous dioctoate, stannous dilaurate, or the dialkyltin salts of aliphatic carboxylic acids, e.g. dibutyltin diacetate, dibutyltin dilaurate, or the like. The amounts usually used of the catalysts are from 0.0001 to 0.1 part by weight per 100 parts by weight of polyhydroxy compound (b).

Alongside catalysts (d), conventional auxiliaries and/or additives (e) may also be added to the structural components (a) to (c). By way of example, mention may be made of blowing agents, surface-active substances, fillers, flame retardants, nucleating agents, antioxidants, lubricants and mold-release agents, dyes and pigments, further stabilizers if appropriate in addition to the inventive stabilizer mixture, e.g. with respect to hydrolysis, light, heat or discoloration, inorganic and/or organic fillers, reinforcing agents, and plasticizers. In one preferred embodiment, component (e) also includes hydrolysis stabilizers, such as polymeric and low-molecular-weight carbodiimides. In another embodiment, the TPU can comprise a phosphorus compound. In one preferred embodiment, phosphorus compounds used are organophosphorus compounds of trivalent phosphorus, examples being phosphites and phosphonites. Examples of suitable phosphorus compounds are triphenyl phosphate, diphenyl alkyl phosphate, phenyl dialkyl phosphite, tris(nonylphenyl) phosphite, trilauryl phosphite, trioctadecyl phosphite, distearyl pentaerythritol diphosphite, tris(2,4-di-tert-butylphenyl) phosphite, phosphite, distearyl pentaerythritol diphosphite, di(2,4-di-tert-butylphenyl) pentaerythritol diphosphite, tristearyl sorbitol triphosphite, tetrakis(2,4-di-tert-butylphenyl) 4,4′-diphenylenediphosphonite, trisisodecyl phosphite, diisodecyl phenyl phosphite, and diphenyl isodecyl phosphite, or a mixture thereof.

The phosphorus compounds are particularly suitable when they are difficult to hydrolyze, since the hydrolysis of a phosphorus compound to give the corresponding acid can lead to degradation of the polyurethane, in particular of the polyester urethane. Accordingly, the phosphorus compounds particularly suitable for polyester urethanes are those which are particularly difficult to hydrolyze. Examples of these phosphorus compounds are dipolypropylene glycol phenyl phosphite, triisodecyl phosphite, triphenyl monodecyl phosphite, trisisononyl phosphite, tris(2,4-di-tert-butylphenyl) phosphite, tetrakis(2,4-di-tert-butylphenyl)-4,4′-biphenylylene diphosphonite, and di(2A-di-tert-butylphenyl)-pentaerythritol diphosphite, or a mixture thereof.

Fillers that can be used are organic and inorganic powders or fibrous materials, or else a mixture thereof. Examples of organic fillers that can be used are wood flour, starch, flax fibers, hemp fibers, ramie fibers, jute fibers, sisal fibers, cotton fibers, cellulose fibers, or aramid fibers. Examples of inorganic fillers that can be used are silicates, barite, glass beads, zeolite, metals or metal oxides. It is preferable to use pulverulent inorganic substances, such as talc, chalk, kaolin, (Al2(Si2O5)(OH)4), aluminum hydroxide, magnesium hydroxide, aluminum nitrite, aluminum silicate, barium sulfate, calcium carbonate, calcium sulfate, silica, powdered quartz, Aerosil, alumina, mica, or wollastonite, or inorganic substances in the form of beads or fibers, e.g. iron powder, glass beads, glass fibers, or carbon fibers. The average particle diameters or, in the case of fillers in the form of fibers, the length should be in the region of the cell size or smaller. Preference is given to an average particle diameter in the range from 0.1 to 100 μm, preferably in the range from 1 to 50 μm.

Besides the components a) and b) mentioned, and if appropriate, c), d) and e), it is also possible to use chain regulators, usually with molar mass of from 31 to 499. These chain regulators are compounds which have only one functional group reactive toward isocyanates, examples being monohydric alcohols, monobasic amines, and/or monohydric polyols. These chain regulators can give precise control of flow behavior, in particular in the case of TPUs. The amount of chain regulators which may generally be used is from 0 to 5 parts by weight, preferably from 0.1 to 1 part by weight, based on 100 parts by weight of component b), and the chain regulators are defined as part of component (c).

All of the molar masses mentioned in relation to components (a) to (d) have the unit [g/mol].

To adjust the hardness of the TPUs, the molar ratios of the structural components (b) and (c) may be varied relatively widely. Successful molar ratios of component (b) to the entire amount of chain extenders (c) to be used are from 10:1 to 1:10, in particular from 1:1 to 1:4, and the hardness of the TPUs here rises as content of (c) increases.

The reaction can take place at conventional indices, preferably with an index of from 60 to 120, particularly preferably at an index of from 80 to 110. The index is defined via the ratio of the total number of isocyanate groups used during the reaction in component (a) to the number of groups reactive toward isocyanates, i.e. to the active hydrogen atoms, in components (b) and (c). If the index is 100, there is one active hydrogen atom, i.e. one function reactive toward isocyanates, in components (b) and (c) for each isocyanate group in component (a). If indices are above 100, there are more isocyanate groups than OH groups present.

The TPUs can be produced by the known processes continuously, for example using reactive extruders, or the belt process, by the one-shot method or the prepolymer method, or batchwise by the known prepolymer process. The components (a), (b) and, if appropriate, (c), (d), and/or (e) reacting in these processes can be mixed with one another in succession or simultaneously, whereupon the reaction immediately begins.

In the extruder process, structural components (a), (b), and, if appropriate, (c), (d), and/or (e) are introduced individually or in the form of a mixture into the extruder, e.g. at temperatures of from 100 to 280° C., preferably from 140 to 250° C., and reacted, and the resultant TPU is extruded, cooled, and pelletized. It can, if appropriate, be advisable to heat-condition the resultant TPU prior to further processing at from 80 to 120° C., preferably from 100 to 110° C., for a period of from 1 to 24 hours.

The expandable thermoplastic polyurethane particles preferably comprise a blowing agent and optionally from 5 to 80% by weight of organic and/or inorganic fillers, based on the total weight of the expandable thermoplastic polyurethane particles. Suitable blowing agents include organic liquids, inorganic gases, or a mixture thereof. Liquids that can be used comprise halogenated hydrocarbons, but preference is given to saturated, aliphatic hydrocarbons, in particular those having from 3 to 8 carbon atoms. Suitable inorganic gases are nitrogen. air, ammonia, or carbon dioxide. Hydrocarbons (preferably halogen-free) have good suitability, in particular C4-10-alkanes, for example the isomers of butane, of pentane, of hexane, of heptane, and of octane, particularly preferably secpentane. Other suitable blowing agents are bulkier compounds, examples being alcohols, ketones, esters, ethers, and organic carbonates.

The amount of blowing agent is preferably from 0.1 to 40 parts by weight, in particular from 0.5 to 35 parts by weight, and particularly preferably from 1 to 30 parts by weight, based on 100 parts by weight of thermoplastic polyurethane used.

### Non-Crosslinkable Thermoplastic Polyurethane Composition:

The non-crosslinkable thermoplastic polyurethane composition may comprise a blowing agent, for example a blowing agent described above, or may be free of blowing agents. The term “free of blowing agents” relates to non-crosslinkable thermoplastic polyurethane compositions comprising less than 5 wt.-%, in particular 0 wt. %, of blowing agent, based on the total weight of the thermoplastic polyurethane composition.

The non-crosslinkable thermoplastic polyurethane can be obtained as previously described in relation to the expandable/expanded thermoplastic polyurethane particles.

Suitable non-crosslinkable thermoplastic polyurethane compositions include non-crosslinkable polyurethane compositions containing blowing agent(s) or being free of blowing agent(s) and being commercially available, for example under the tradename Elastollan® from BASF SE.

### Step (e):

In the first alternative of step (e) (i.e. step (e-1)), the mold (MO) is heated to expand the non-crosslinkable polymer composition (C2) and optionally fuse the expanded non-crosslinkable polymer composition (C2) while at least partially curing the coating composition (C1). This alternative may be preferred if the non-crosslinkable polymer composition (C2) comprises at least one blowing agent which can be expanded by use of heat, such as steam. In case of expandable thermoplastic polyurethane particles containing a blowing agent, the heat is used to simultaneously expand and fuse the particles to obtain the non-crosslinked polymer material. At the same time, the coating composition (C1) applied and dried in step (b) is cured by the use of heat upon formation of the non-crosslinked polymer material, thus resulting in a high adhesion of the cured coating layer on the non-crosslinked polymer material without negatively influencing the good demoldability obtained when using the coating composition (C1). It may be preferred to perform step (e-1) at temperatures of 100 to 140° C. This ensures that the particles are sufficiently expanded and fused while at the same time allowing sufficient curing of the coating composition (C1).

In the second alternative of step (e) (i.e. step (e-2)), the mold (MO) is heated to fuse the non-crosslinkable polymer composition (C2) while at least partially curing the coating composition (C1). This alternative may be preferred if the non-crosslinkable polymer composition (C2) is selected from expanded thermoplastic polyurethane particles, which are fused by heat. The heating may be performed using steam at a temperature of 100 to 140° C. or by radiofrequency. A suitable radiofrequency is 3 to 8 kV, preferably of 4 to 6 kV. The mold (MO) may be irradiated with the radiofrequency for a duration of 300 to 1000 seconds, preferably 500 to 700 seconds. To ensure sufficient fusing of the expanded thermoplastic polyurethane particles while crosslinking the coating composition (C1), the mold is heated to at least 45° C. if radiofrequency is used. Surprisingly, the use of radiofrequency allows to sufficiently fuse the expanded thermoplastic polyurethane particles while at the same time allowing sufficient cure of the coating composition (C1), resulting in a coated non-crosslinked polyurethane material having good optical as well as mechanical properties.

In the third alternative of step (e) (i.e. step (e-3)), the non-crosslinkable polymer composition (C2) is hardened while at least partially curing the coating composition (C1). This alternative may be preferred if the non-crosslinkable polymer composition (C2) is selected from thermoplastic polyurethane compositions, which are injected into the mold in a molten state and are hardened in the mold, for example by cooling. Coated non-crosslinked polymer materials resulting from said alternative are, for example, coated compact thermoplastic polyurethane materials. The heat generated by applying the non-crosslinkable polymer composition (C2) into the mold (MO) is high enough to sufficiently cure the coating composition (C1), thus ensuring sufficient adhesion of the coating layer produced from the coating composition (C1) on the non-crosslinked polymer material.

Optional Step (e-4):

Optional step (e-4) may be performed after performing step (e-1) or (e-2) or (e-3), for example if a further polymer composition is to be injected or inserted into the mold (MO). The further polymer composition may be a non-crosslinkable polymer composition or a crosslinkable polymer composition (i.e. a polymeric composition comprising reactive components which react chemically with each other during formation of the polymer material). Suitable non-crosslinkable polymer compositions include the non-crosslinkable polymer compositions described in relation to step (d) above. Suitable crosslinkable polymer compositions include polyurethane compositions comprising at least one polyol, at least one polyisocyanate and at least one blowing agent. The blowing agent added to the polyol component to form the polymer material is usually water, which reacts with part of the polyisocyanate to form carbon dioxide, the reaction therefore being accompanied by foaming. Soft to elastic polymeric materials, especially flexible polymeric materials such as foams, are obtained using long-chain polyols. If short-chain polyols are used, highly crosslinked structures are formed, leading generally to the formation of rigid polymeric materials, such as rigid foams. The polyols used in producing the polyurethane materials preferably comprise polyester polyols, polyether polyols and/or polyester polyether polyols, and are accordingly selected preferably from the group of the aforesaid polyols. Fibers as well may be admixed to the polymer compositions. When such formulations are foamed, the products are known as fiber-reinforced foams. Fibers are preferably used when producing rigid polymeric materials.

The polymer composition used in step (e-4) may be the same or a different polymer composition than used in step (e-1) or (e-2) or (e-3). Formation of the polymer material from the polymer composition may be accomplished as described in step (e-1) or (e-2) or (e-3). Step (e-4) may be repeated as often as desired. The polymer compositions may differ, for example, in density, in color, or in the material used. In this way, multilayer soles can be produced, the properties of the soles being adapted through the choice of the polymer compositions. If this step is carried out, parts of the molding tool are preferably moved before injection of the polymer composition in this step in such a way as to form a hollow compartment into which the polymer composition is injected or inserted. This may be done, for example, by moving the core plate or the mold part that closes the mold (MO) at the top.

### Step (f):

In process step (f) of the process of the invention, the mold (MO) is opened and the molded non-crosslinked polymer material comprising at least one at least partially coated surface is removed. This may be accomplished by altering at least one part of the mold, in particular hydraulically, before the mold (MO) is opened. Furthermore, provision may be made requiring closure mechanisms for the closing of the mold (MO) to be opened before the mold (MO) is opened. Removing of the coated material may be performed using commonly used tools. Opening of the mold and/or removing of the coated material may be performed either manually or automatically.

Optional step (g):

The material obtained in step (f) may be post-treated, for example by trimming and/or polishing and/or coating the obtained material. The material obtained after step (f) may be coated directly—without a sanding procedure, optionally after simple cleaning—with further coating materials such as, for example, with one or more basecoat materials and/or one or more clearcoat materials, to form one or more basecoat films and/or one or more clearcoat films, respectively. The material obtained after step (f) is preferably not coated with a primer or primer surfacer coating layer. Instead, a basecoat film or a topcoat film, more particularly a clearcoat film, is applied directly to the material obtained after step (f). The applied basecoat film(s) and/or clearcoat film(s) can be cured separately or jointly.

As basecoat and topcoat, more particularly clearcoat, materials, it is possible to use all basecoat and clearcoat materials, respectively, that are conventionally employed in lacquering. Such basecoat and clearcoat materials are available, for example, from BASF Coatings GmbH; clearcoat materials having been found particularly suitable are, in particular, clearcoat materials of the EverGloss product line.

### Further Process Steps:

The inventive process may include a cleaning step (h) after removal of the coated material in step (f). In said cleaning step, the mold (MO) is cleaned, for example by manual or automatic cleaning. The mold (MO) may be cleaned by sandblasting or by use of organic solvents. This cleaning step ensures that the surface of the molding parts of the mold (MO) do not comprise unwanted contaminants and thus avoids lowering the adhesion of the coating composition (C1) to the surface of the molding parts and hence the demolding properties as well as the optical and mechanical properties of the coated material.

In this context it is advantageous if step (h) is carried out after 20 to 100, more particularly 20 to 50, repetitions of the process steps (a) to (f). Cleaning of the mold (MO) after the production of 20 to 100 coated materials permits an efficient process regime, since the mold (MO) does not have to be cleaned after being used only once. Furthermore, the amount of cleaning wastes is reduced.

The process of the invention allows injection-molded, coated non-crosslinked polymer materials to be produced, the materials being able to be processed further without costly and inconvenient aftertreatment. Surprisingly, the coating obtained on the non-crosslinked polymer material by the use of the coating composition (C1) has a sufficient adhesion even though non-crosslinking polymer compositions are used, i.e. a crosslinking of the polymer composition and the coating composition (C1) during curing cannot take place. Moreover, the formed coating layer is highly elastic or flexible and also UV-resistant and nonshiny, hence resulting not only in damage-free demolding of the coated material but also in effective protection of the coated material produced with respect to environmental influences such as UV radiation, dirt or the like, as early as directly after the production of the coated material. Because the coating composition (C1) used in the process of the invention at the same time has a release effect, this composition can be used both as a release agent and also as a coating composition. Accordingly there is no need for the use of a separate release agent, requiring costly and inconvenient removal of residues of said agent from the formed non-crosslinked polymer material before aftertreatment of said material. Since only small residues of the coating composition remain in the mold (MO), the molds (MO) do not have to be cleaned before each application of the coating composition (C1).

### Inventive Molded Non-Crosslinked Polymer Material Comprising at Least One at Least Partially Coated Surface:

After the end of the method of the invention, the result is a molded non-crosslinked polymer material comprising at least one at least partially coated surface of the invention.

The coating layer formed during the formation of the non-crosslinked polymer material inside the mold shows a good appearance as well as a sufficient flexibility and a high adhesion to the polymer material while at the same time functioning as release agent to facilitate damage free removal of the coated non-crosslinked polymer material from the mold.

The invention is described in particular by the following embodiments:
1. A process for producing molded non-crosslinked polymer materials comprising at least one at least partially coated surface, said process comprising the following steps in the stated order:
   (a) providing a closable, three dimensional mold (MO) having at least two mold parts which are movable relative to each other and which form a mold cavity with at least two inner surfaces (SU),
   (b) applying a coating composition (C1) on at least a part of at least one inner surface (SU) and drying the applied coating composition (C1);
   (c) optionally inserting at least one material (M1) into the mold (MO) and heating the mold (MO);
   (d) closing the mold (MO) and injecting a non-crosslinkable polymer composition (C2) into the closed mold (MO) or introducing a non-crosslinkable polymer composition (C2) into the open mold (MO) and closing said mold (MO);
   (e-1) heating the mold (MO) to expand the non-crosslinkable polymer composition (C2) and optionally fuse the expanded non-crosslinkable polymer composition while at least partially curing the coating composition (C1), or
   (e-2) heating the mold (MO) to fuse the non-crosslinkable polymer composition (C2) while at least partially curing the coating composition (C1); or
   (e-3) harden the non-crosslinkable polymer composition (C2) while at least partially curing the coating composition (C1);
   (f) opening of the mold (MO) and removing the molded non-crosslinked polymer material comprising at least one at least partially coated surface;
   (g) optionally post-treating of the material obtained after step (f), wherein the coating composition (C1) comprises
   (i) at least one solvent L;
   (ii) at least one compound of the general formula (I)

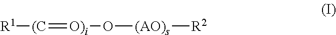

in which R¹ is a saturated or unsaturated aliphatic hydrocarbon radical having 6 to 30 carbon atoms,
R² is H,
AO stands for one or more alkylene oxide radicals selected from the group consisting of ethylene oxide, propylene oxide and butylene oxide,
r is 0 or 1, and
s is 0 to 30;
(iii) at least one polysiloxane of the general formula (II)

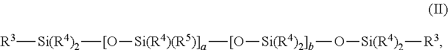

in which
R³ and R⁴, in each case independently of one another, are a methyl group or a (HO—CH₂)₂—C(CH₂—CH₃)—CH₂—O—(CH₂)₃—* radical,
R⁵ is a methyl group,
a is 0 or 1 to 10, and
b is 3 to 30;
(iv) at least one binder;
(v) at least one crosslinking agent; and
(vi) optionally at least one polyether-modified alkylpolysiloxane.
2. The process of embodiment 1, wherein the process is a manual process or an automatic process.
3. The process of embodiment 1 or 2, wherein the mold parts are selected from metallic mold parts, preferably aluminum, steel, nickel or copper mold parts, very preferably aluminum and/or steel mold parts, and/or from polymeric mold parts, preferably polyamide mold parts.
4. The process according to any one of the preceding embodiments, wherein the coating composition (C1) has a viscosity of 10 to 60 s, more particularly of 20 to 30 s (DIN4 flow cup), measured according to DIN EN ISO 2431 (March 2012).
5. The process according to any one of the preceding embodiments, wherein the coating composition (C1) has a solids content of 30 to 60 wt. %, preferably of 35 to 55 wt. %, more preferably of 40 to 50 wt. %, very preferably of 42 to 48 wt. %, measured according to ASTM D2369 (2015) (110° C., 60 min).
6. The process according to any one of the preceding embodiments, wherein the at least one solvent L is selected from organic solvents, water, and mixtures thereof, in particular from organic solvents.
7. The process according to any one of the preceding embodiments, wherein the at least one solvent L is present in a total amount of 40 to 70 wt. %, more preferably 45 to 65 wt. %, even more preferably 50 to 60 wt. %, very preferably 52 to 58 wt. %, based in each case on the total weight of the coating composition (C1).
8. The process according to any one of the preceding embodiments, wherein R¹ in the general formula (I) is a saturated or unsaturated aliphatic hydrocarbon radical having 10 to 24 carbon atoms.
9. The process according to any one of the preceding embodiments, wherein AO in the general formula (I) stands for one or more alkylene oxide radicals selected from the group consisting of ethylene oxide and propylene oxide.
10. The process according to any one of the preceding embodiments, wherein and the ethylene oxide fraction in the entirety of the radicals AO is more than 50 mol %, preferably at least 70 mol %, very preferably at least 90 mol %, based on the total molar amounts of AO radicals.
11. The process according to any one of the preceding embodiments, wherein s is 0 or s is 6 to 20.
12. The process according to any one of the preceding embodiments, wherein the coating composition (C1) comprises at least one compound of formula (Ia)

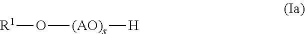

and at least one compound of formula (Ib)

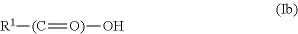

in which
R¹ is a saturated or unsaturated, aliphatic hydrocarbon radical having 6 to 30 carbon atoms, preferably a saturated or unsaturated, aliphatic hydrocarbon radical having 12 to 22 carbon atoms,
R¹′ is a saturated or unsaturated, aliphatic hydrocarbon radical having 6 to 30 carbon atoms, preferably an unsaturated, aliphatic hydrocarbon radical having 21 carbon atoms,
AO stands for one or more alkylene oxide radicals selected from the group consisting of ethylene oxide, propylene oxide and butylene oxide, preferably ethylene oxide, and
S is 2 to 28, preferably 6 to 20.
13. The process according to any one of the preceding embodiments, wherein the at least one compound of the general formula (I) is present in a total amount of 0.1 to 10 wt. %, more preferably 0.5 to 5 wt. %, more particularly 1.5 to 4 wt. %, based in each case on the total weight of the coating composition (C1).
14. The process according to any one of the preceding embodiments, wherein radical R³ in the general formula (II) is a (HO—CH₂)₂—C(CH₂—CH₃)—CH₂—O—(CH₂)₃—* radical and radicals R⁴ and R⁵ in the general formula (II) are each a methyl group.
15. The process according to any one of the preceding embodiments, wherein a in the general formula (II) is 0 and b in the general formula (II) is 7 to 14.
16. The process according to any one of the preceding embodiments, wherein the at least one polysiloxane of the general formula (II) in present in a total amount of 0.1 to 5 wt. %, preferably 0.5 to 4 wt. %, more particularly 0.8 to 2.5 wt. %, based in each case on the total weight of the coating composition (C1).
17. The process according to any one of the preceding embodiments, wherein the at least one binder is present in a total amount of 20 to 50 wt. % solids, preferably of 25 to 40 wt. % solids, more particularly of 25 to 35 wt. % solids, based in each case on the total weight of the coating composition (C1).
18. The process according to any one of the preceding embodiments, wherein the at least one binder is selected from the group consisting of (i) poly(meth)acrylates, more particularly hydroxy-functional and/or carboxylate-functional and/or amine-functional poly(meth)acrylates, (ii) polyurethanes, more particularly hydroxy-functional and/or carboxylate-functional and/or amine-functional polyurethanes, (iii) polyesters, more particularly polyester polyols, (iv) polyethers, more particularly polyether polyols, (v) copolymers in the stated polymers, and (vi) mixtures thereof, preferably from hydroxy-functional poly(meth)acrylates and/or polyester polyols.
19. The process according to embodiment 18, wherein the hydroxy-functional poly(meth)acrylate is present in a total amount of 10 wt. % to 97 wt. %, preferably of 40 to 70 wt. %, very preferably of 40 to 50 wt. %, based in each case on the total weight of the solids content of all binders present in the coating composition (C1).
20. The process according to embodiment 18 or 19, wherein the polyester polyol is present in a total amount of 40 wt. % to 97 wt. %, preferably of 40 to 70 wt. %, more particularly of 50 to 65 wt. %, based in each case on the total weight of the solids content of all binders present in the coating composition (C1).
21. The process according to any one of the preceding embodiments, wherein the crosslinking agent is selected from the group consisting of amino resins, polyisocyanates, blocked polyisocyanates, polycarbodiimides, photoinitiators, and mixtures thereof, preferably polyisocyanates.
22. The process according to embodiment 21, wherein the polyisocyanate comprises at least one isocyanurate ring or at least one iminooxadiazinedione ring, preferably at least one isocyanurate ring.
23. The process according to any one of the preceding embodiments, wherein the at least one crosslinking agent is present in a total amount of 10 wt. % to 40 wt. %, preferably of 10 to 30 wt. %, more particularly of 15 to 25 wt. %, based in each case on the total weight of the coating composition (C1).
24. The process according to any one of the preceding embodiments, wherein the molar ratio of the functional groups of the crosslinking agent, more particularly of the NCO groups, to the sum of the groups in the at least one binder that are reactive toward the functional groups of the crosslinking agent, more particularly hydroxyl groups, is 0.4:1 to 1:1, preferably 0.65:1 to 0.85:1, very preferably 0.7:1 to 0.8:1.
25. The process according to any one of the preceding embodiments, wherein the polyether-modified alkylpolysiloxane comprises at least one structural unit (R⁷)₂(OR⁶) SiO_{1/2} and at least one structural unit (R⁷)₂SiO_{2/2}, where R⁶ is an ethylene oxide, propylene oxide, and butylene oxide group, more particularly a mixture of ethylene oxide and propylene oxide and butylene oxide groups, and R⁷ is a C1-C10 alkyl group, more particularly a methyl group.
26. The process according to embodiment 25, wherein the polyether-modified alkylpolysiloxane has a molar ratio of the structural unit (R⁷)₂(OR⁶) SiO_{1/2} to the structural unit (R⁷) 2SiO_{2/2} of 1:10 to 1:15, more particularly of 1:10 to 1:13.
27. The process according to any one of the preceding embodiments, wherein the at least one polyether-modified alkylpolysiloxane is present in a total amount of 0 wt. % or of 0.1 to 6 wt. %, preferably 0.5 to 4 wt. %, more particularly 0.8 to 3 wt. %, based in each case on the total weight of the coating composition (C1).
28. The process according to any one of the preceding embodiments, wherein the coating composition (C1) further comprises at least one crosslinking catalyst.
29. The process according to embodiment 28, wherein the crosslinking catalyst is selected from the group of the bismuth carboxylates, preferably bismuth carboxylates of general formula (III)

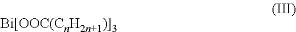

where n=5 to 15, preferably n=7 to 13, more particularly n=9 to 11.
30. The process according to embodiment 28 or 29, wherein the at least one crosslinking catalyst is present in a total amount of 0.01 wt. % to 3.5 wt. %, preferably of 0.1 to 2 wt. %, very preferably of 0.4 to 1.5 wt. %, based in each case on the total weight of the coating composition (C1).
31. The process according to any one of the preceding embodiments, wherein the coating composition further comprises at least one color and/or effect pigment.
32. The process according to any one of the preceding embodiments, wherein the coating composition further comprises at least one additive selected from the group consisting of wetting agents and/or dispersants, rheological assistants, flow control agents, UV absorbers, and mixtures thereof is additionally present.
33. The process according to embodiment 32, wherein the at least one additive is present in a total amount of 0 wt. % to 10 wt. %, based on the total weight of the coating composition (C1).
34. The process according to any one of the preceding embodiments, wherein the coating composition (C1) is dried in process step (b) for a period of 20 seconds to 60 minutes, preferably of 20 seconds to 25 minutes.
35. The process according to any one of the preceding embodiments, wherein the coating composition (C1) is dried in process step (b) at a temperature of 20 to 100° C., more preferably 20 to 70° C.
36. The process according to any one of the preceding embodiments, wherein the dry film thickness of the dried coating composition (C1) in process step (b) is 20 to 120 μm, more particularly 25 to 100 μm.
37. The process according to any one of the preceding embodiments, wherein the material (M1) inserted in process step (c) is an outsole, more particularly an outsole made of thermoplastic polyurethane.
38. The process according to any one of the preceding embodiments, wherein the molding tool is heated in process step (c) to 20 to 100° C., more preferably to 30 to 90° C., very preferably to 40 to 80° C., more particularly to 50 to 70° C.
39. The process according to any one of the preceding embodiments, wherein the non-crosslinkable polymer composition (C2) is selected from expanded thermoplastic polyurethane particles, expandable thermoplastic polyurethane particles, non-crosslinkable thermoplastic polyurethane, non-crosslinkable polyvinyl chloride, non-crosslinkable polycarbonate, non-crosslinkable polystyrene, non-crosslinkable polyethylene, non-crosslinkable polypropylene, non-crosslinkable acrylonitrile butadiene styrene, non-crosslinkable polyoxymethylene or non-crosslinkable polytetrafluoroethylene, preferably from expanded thermoplastic polyurethane particles and non-crosslinkable thermoplastic polyurethane compositions.
40. The process of embodiment 39, wherein the expanded thermoplastic polyurethane particles have a density of 5 g/l to 600 g/l.
41. The process of embodiment 39 or 40, wherein the expanded thermoplastic polyurethane particles have an average diameter of 0.2 mm to 20 mm, preferably of 0.5 mm to 15 mm, very preferably of 1 mm to 12 mm.
42. The process of any one of embodiments 39 to 41, wherein the expanded thermoplastic polyurethane particles and/or the expandable thermoplastic polyurethane particles are spherical.
43. The process of any one of embodiments 39 to 42, wherein the expanded thermoplastic polyurethane particles and/or the expandable thermoplastic polyurethane particles are based on a polyether alcohol or a polyester alcohol.
44. The process of any one of embodiments 39 to 43, wherein expandable thermoplastic polyurethane particles have an average diameter of 0.2 to 10 mm.
45. The process of any one of embodiments 39 to 44, wherein expandable thermoplastic polyurethane particles comprise at least one blowing agent and optionally 5 to 80 wt. % organic and/or inorganic fillers, based on the total weight of the expandable thermoplastic polyurethane particles.
46. The process of any one of embodiments 39 to 45, wherein the non-crosslinkable thermoplastic polyurethane composition comprises at least one blowing agent or is free of blowing agents.
47. The process according to any one of the preceding embodiments, wherein step (e-1) is performed at a temperature of 100 to 140° C.
48. The process according to any one of the preceding embodiments, wherein step (e-2) is performed using steam at a temperature of 100 to 140° C. or using radiofrequency.
49. The process according to embodiment 48, wherein a radiofrequency of 3 to 8 kV, preferably 4 to 6 kV, for 300 to 1000 seconds, preferably 500 to 700 seconds, at a temperature of at least 45° C. is used.
50. The process according to any one of the preceding embodiments, wherein the post-treating step (g) comprises trimming and/or polishing and/or coating the material obtained in step (f).
51. The process according to embodiment 50, wherein coating the material obtained in step (f) comprises, without an intermediate sanding procedure, applying at least one basecoat layer and/or at least one clearcoat layer and curing the applied basecoat layers(s) and/or the applied clearcoat layers(s) separately or jointly.
52. The process according to any one of the preceding embodiments, wherein the process comprises a cleaning step (h) after removal of the coated material in process step (f).
53. The process according to embodiment 52, wherein the further cleaning step (h) is carried out after 20 to 100, more particularly 20 to 50, repetitions of process steps (a) to (f).
54. A molded non-crosslinked polymer material comprising at least one at least partially coated surface, produced by the process according to in any one of embodiments 1 to 53.

### Examples

The present invention will now be explained in greater detail through the use of working examples, but the present invention is in no way limited to these working examples. Moreover, the terms “parts”, “%” and “ratio” in the examples denote “parts by mass”, “mass %” and “mass ratio” respectively unless otherwise indicated.

### 1. Methods of Determination:

### 1.1 Solids Content (Solids, Non-Volatile Fraction)

Unless stated otherwise, the solids content (also called proportion of solids, solid-state content, proportion of non-volatiles) was determined to DIN EN ISO 3251:2018-07 at 130° C.; 60 min, starting weight 1.0 g.

### 1.2 Appearance

The appearance of the coated non-crosslinked polymer material was determined by visually assessing the hiding power and color uniformity of the formed coating layer.

### 1.3 Adhesion

The adhesion of the formed coating layer on the non-crosslinked polymer material is tested with the steam jet test according to DIN 55662:2009-12. The results of the steam jet test are evaluated visually according to DIN EN ISO 16925:2014-06 (0: no visible damage, 5=high visible damage).

### 1.5. Demoldability

The success of demoldability of the coated molded non-crosslinked polymer material from the three-dimensional mold is determined by removing the molded material from the mold and visually assessing the obtained molded material. If the coated molded non-crosslinked polymer material could be fully demolded and no damage is detected visually, the demoldability is “OK”. If the molded non-crosslinked polymer material could not be demolded or the molded non-crosslinked polymer material was visually destroyed during demolding, the demoldability is rated “not OK”.

### 1.6. Acid Number

The acid number is determined according to DIN EN ISO 2114 (date: June 2002), using “method A”. The acid number corresponds to the mass of potassium hydroxide in mg required to neutralize 1 g of sample under the conditions specified in DIN EN ISO 2114. The acid number reported corresponds here to the total acid number as specified in the DIN standard, and is based on the solids content.

### 1.7. OH Number

The OH number is determined according to DIN 53240-2:2007-11. The OH groups are reacted by acetylation with an excess of acetic anhydride. The excess acetic anhydride is subsequently split by addition of water to form acetic acid, and the entire acetic acid is back-titrated with ethanolic KOH. The OH number indicates the quantity of KOH in mg that is equivalent to the amount of acetic acid bound in the acetylation of 1 g of sample. The OH number is based on the solids content of the sample.

### 1.8. Number-Average and Weight-Average Molecular Weight

The number-average molecular weight (Mₙ) is determined by gel permeation chromatography (GPC) according to DIN 55672-1 (March 2016). Besides the number-average molecular weight, this method can also be used to determine the weight-average molecular weight (M_{w}) and also the polydispersity d (the ratio of weight-average molecular weight (M_{w}) to number-average molecular weight (Mₙ)). Tetrahydrofuran is used as the eluent. The determination is made against polystyrene standards. The column material consists of styrene-divinylbenzene copolymers.

### 2. Coating Compositions

The following compositions C1-1 to C1-5 were used in the molding process described in point 3. below (all ingredients are given in wt. %):

| | | | C1-1 | C1-2 | C1-3 | C1-4 | C1-5 |
|---|---|---|---|---|---|---|---|
| Mixture | 1 | Parocryl | 5.2 | — | 16.0 | 5.2 | 15 |
| | | 4085 ¹⁾ | | | | | |
| A | 2 | Desmophen | 35.7 | 41.8 | 26.7 | 34.6 | 25 |
| | | 670 BA ²⁾ | | | | | |
| | 3a | Acetone | 5.2 | — | 5.3 | — | 5 |
| | 3b | 1-Methoxypropyl | — | 2.7 | — | 2.6 | — |
| | | acetate | | | | | |
| | 3c | Butylacetate | — | 3.0 | — | 2.9 | — |
| | 4 | Additive | 2.4 | 2.8 | 2.5 | 2.3 | 2.3 |
| | | MI-8010 ³⁾ | | | | | |
| | 5 | Silmer | 1.4 | 1.5 | 1.5 | 1.4 | 1.4 |
| | | OHT Di-10 ⁴⁾ | | | | | |
| | 6 | DriCAT ⁵⁾ | 1.5 | 1.6 | 1.6 | 1.2 | 1.5 |
| | 7a | Yellow color | 12.9 | — | — | — | — |
| | | paste ⁶⁾ | | | | | |
| | 7b | Black color | — | 13.3 | — | — | — |
| | | paste ⁷⁾ | | | | | |
| | 7c | Blue color | — | — | 6.7 | 5.0 | 5.0 |
| | | paste ⁸⁾ | | | | | |
| | 7d | White color | — | — | 6.7 | — | — |
| | | paste ⁹⁾ | | | | | |
| | 7e | Aluminium | — | — | — | 7.5 | 7.5 |
| | | paste ¹⁰⁾ | | | | | |
| Hardner | 8 | Butyl | 12.9 | 13.3 | 13.3 | 15 | 15 |
| | | acetate | | | | | |
| | 9 | Desmodur | 19.4 | 20.0 | 20.0 | 22.5 | 22.5 |
| | | N 3800 ¹¹⁾ | | | | | |
| | 10 | Acetone | 3.2 | — | — | — | — |

¹⁾ hydroxyl-functional poly(meth)acrylate having a hydroxyl number of 82.5 mg KOH/g, an acid number of 10 mg KOH/g, Mₙ about 6800 g/mol, M_{w} about 17 000 g/mol (BASF SE),
²⁾ polyester polyol having a hydroxyl number of 115 mg KOH/g and a hydroxyl functionality of about 3.5 (Covestro),
³⁾ mixture of compounds of the formula R¹-(C═O)ᵣ-O-(AO)ₛ-R², composed of (a) R¹ = mixture of saturated and unsaturated hydrocarbon radicals having 12 to 22 carbon atoms, r = 0, AO = mixture of primarily ethylene oxide units and a few propylene oxide units, and R² = H (Mₙ ≈ 650 g/mol); and (b) R¹ = unsaturated hydrocarbon radical having 21 carbon atoms, s = 0, and R² = H (Münch Chemie International GmbH),
⁴⁾ hydroxy-modified polysiloxane of formula (III) comprising the above-recited residues (Siltec Gmbh & Co. KG),
⁵⁾ bismuth neodecanoate in neodecanoic acid (Dura Chemicals),
⁶⁾ The yellow color paste was prepared by mixing 50 wt.-% of a CAB solution (15 wt.-% CAB 381-2BP in 85 wt.-% butyl acetate), 19 wt.-% Irgazin yellow L (BASF Colors & Effects GmbH), 10 wt. % Maprenal MF650 (Ineos), 5 wt.-% butylglyol acetate and 16 wt.-% butyl acetate,
⁷⁾ The black color paste was prepared by mixing 21 wt. % SOLSPERSE 32500 (Lubrizol Corporation), 5 wt. % Butylglycol acetate, 8 wt. % butanol, 16 wt. % butyl acetate, 10 wt. % carbon black (Monarch 1300, Cabot Corporation), 25 wt. % of a polyester resin (Parotal 261284 from BASF Coatings GmbH), 15 wt.-% of a CAB solution (15 wt.-% CAB 381-2BP in 85 wt.-% butyl acetate),
⁸⁾ The blue color paste was prepared by mixing 58.8 wt.-% of a CAB solution (15 wt.-% CAB 381-2BP in 85 wt.-% butyl acetate), 11.8 wt.-% Heliogen blue 6700 F (BASF SE), 11.8 wt. % Maprenal MF650 (Ineos), 5.9 wt.-% butylglyol acetate and 11.7 wt.-% butyl acetate,
⁹⁾ The white color paste was prepared by mixing 50 wt.-% of a CAB solution (15 wt.-% CAB 381-2BP in 85 wt.-% butyl acetate), 20 wt.-% Titan Rutil MT500 MD (Tayca Corporation), 10 wt. % Maprenal MF650 (Ineos), 5 wt.-% butylglyol acetate, 1.7 wt. % isotridecyl alcohol and 13.3 wt.-% butyl acetate,
¹⁰⁾ The aluminum paste was prepared by mixing Stapa ® Metallux 214 aluminum paste (Eckart GmbH) with Glasurit 90-M1 (BAS Coatings GmbH) in a weight ratio of 1:3
¹¹⁾ hexamethylene diisocyanate trimer of isocyanurate type with an NCO content of 11.0 wt. % (Covestro),

Compositions C1-1 to C1-5 were Prepared as Follows:

First of all, respective ingredients 1-6 were mixed to prepare mixture A and ingredients 8 and 9 were mixed to prepare the hardener. Then, mixture A was mixed with the respective color paste 7a-7d and aluminum paste 7e optionally the acetone 10 and the hardener to obtain respective composition C1-1 to C1-5.

### 3. Production of Different Coated Non-Crosslinked Polymer Materials by a Molding Process

Different coated non-crosslinked polymer materials are produced by the following inventive molding process.

### 3.1 Coated Expanded Non-Crosslinked Polyurethane Particle Foam

Composition C1-1 is applied pneumatically (SATA Jet 4000 B HVLP with nozzle 1.0) onto a polyethylene plate, dried 15 to 20 minutes at 23° C. and flashed off for 1.5 minutes at 60° C. The polyethylene plate is inserted into an RF molding machine and represents the bottom of the 3D mold. Afterwards, the cavity of the mold is filled with different expanded thermoplastic polyurethane (eTPU) beads listed in Table 2 and closed. The closed mold is subjected to electromagnetic irradiation with a frequency of 4.7 to 5.5 KV for 626 seconds at a start temperature of 45° C. to fuse the eTPU beads while curing the composition C1-1.

TABLE 2
expanded thermoplastic polyurethane (eTPU) beads
used to prepare the coated non-crosslinked polyurethane
foam (all available from BASF SE):

| Sample No. | eTPU beads | Particle size | |
|---|---|---|---|
| 1 | Infinergy ® 32-100 U10 | ~5 | mm |
| 2 | Infinergy ® X 1125-130 U 000 | ~1-2 | mm |
| 3 | Infinergy ® 210 MP (black) | ~5 | mm |
| 4 | Infinergy ® mini black | ~1-2 | mm |

The mold is opened, and the produced coated non-crosslinked polyurethane polymer material is removed from the mold. The appearance of the coated material as well as the adhesion of the cured coating layer formed from composition C1-1 is tested as described previously. The results are listed in point 4. below.

### 3.2 Coated Non-Crosslinked Polyurethane Foam

Composition C1-2 to C1-5 are each applied pneumatically (SATA Jet 4000 B HVLP with nozzle 1.0) into a 3D aluminum mold having a temperature of 55 to 60° C. and dried as described in Table 3. The mold is inserted into a thermo-foam casting machine (DEMAG ergotech 200/500-610). Afterwards, the cavity of the mold is filled with a polyurethane material and cooled to form the polyurethane material while curing the composition C1-2 or C1-3.

TABLE 3
Components to prepare coated expanded non-crosslinked polyurethane
(TPU) foam (foam materials available from BASF SE):

| | Coating | | |
|---|---|---|---|
| Sample No. | composition | Drying conditions | Foam material |
| 5 | C1-2 | 1.5 min @ 55-60° C. | Elastollan BCF |
| | | | 90A15 TSG |
| 6 | C1-3 | 1.5 min @ 55-60° C. | Elastollan BCF |
| | | | 90A15 TSG |
| 7 | C1-4 | 1 min @ 55-60° C. | Elastollan |
| | | | BCF 90A15 |
| 8 | C1-5 | 1 min @ 55-60° C. | Elastollan |
| | | | BCF 90A15 |

The mold is opened, and the produced coated non-crosslinked polyurethane polymer material is removed from the mold. The appearance of the coated material as well as the adhesion of the cured coating layer formed from composition C1-2 to C1-5 is tested as described previously. The results are listed in point 4. below.

### 4. Results

### 4.1 Coated Expanded Non-Crosslinked Polyurethane Particle Foam

Samples 2 and 4 resulting from the inventive process show a homogenously colored coating layer, i.e. color differences in the coating layer are not visible despite the wavy surface resulting from fusing the eTPU beads, while samples 1 and 3 resulting from the inventive process show slight color differences in the colored coating layer on the wavy surface due to the larger particle sizes of the used eTPU beads. The coating layer resulting from composition C1-1 on the fused eTPU beads has a high hiding power because a difference in the appearance of the coated foam material prepared from white and black eTPU beads could not be detected visually.

Samples 1 to 4 resulting from the inventive process could be easily demolded from the mold and the demolded foam materials do not show any visual damages. Thus, the demoldabiltiy was rated “OK” for samples 1 to 4.

The adhesion of the coating layer formed from coating composition C1-1 during the inventive process on the fused eTPU particles was determined by the steam jet test to be 2a. A slight delamination along the blasting line was detected which is assumed to be due to material failure of the eTPU.

### 4.2 Coated Expanded Non-Crosslinked Polyurethane Foam

Samples 5 to 8 resulting from the inventive process show a homogenously colored coating layer, i.e. no color differences were visible in the coating layer, having a sufficiently high hiding power, i.e. the underlying substrate was no longer visible through the coating layer. Moreover, coating layers of samples 5 and 6 are highly flexible, thus allowing bending of the coated foam material without any damage to the coating layer.

Samples 5 to 8 resulting from the inventive process could be easily demolded from the mold and the demolded foam materials do not show any visual damages. Thus, the demoldabiltiy was rated “OK” for samples 5 to 8.

The adhesion of the coating layer formed from coating compositions C1-2 to C1-5 during the inventive process on the expanded and compact TPU was determined by the steam jet test to be 2a. A slight delamination along the blasting line was detected which is assumed to be due to material failure of the eTPU.

### 5. Discussion of the Results

The examples demonstrate that the inventive process results in coated non-crosslinked polymer materials having a good appearance as well as a high demoldability, i.e. allowing damage-free removal of the coated polymer material from the mold without the use of external release agents. The coating layer can be formed during the production of the non-crosslinked polymer material, thus rendering post-coating processes of non-crosslinked polymer materials superfluous. Moreover, the formed coating layers have a high flexibility, thus allowing to be used in combination with flexible polymer materials, an excellent adhesion to the underlying substrate and good optical properties, i.e. a high hiding power and a uniform color.

1. A process for producing molded non-crosslinked polymer materials comprising at least one at least partially coated surface, said process comprising the following steps in the stated order:
(a) providing a closable, three-dimensional mold (MO) having at least two mold parts which are movable relative to each other and which form a mold cavity with at least two inner surfaces (SU),
(b) applying a coating composition (C1) on at least a part of at least one inner surface (SU) and drying the applied coating composition (C1);
(c) optionally inserting at least one material (M1) into the mold (MO) and heating the mold (MO);
(d) closing the mold (MO) and injecting a non-crosslinkable polymer composition (C2) into the closed mold (MO) or introducing a non-crosslinkable polymer composition (C2) into the open mold (MO) and closing said mold (MO);
(e-1) heating the mold (MO) to expand the non-crosslinkable polymer composition (C2) and optionally fuse the expanded non-crosslinkable polymer composition while at least partially curing the coating composition (C1), or (e-2) heating the mold (MO) to fuse the non-crosslinkable polymer composition (C2) while at least partially curing the coating composition (C1); or
(e-3) harden the non-crosslinkable polymer composition (C2) while at least partially curing the coating composition (C1);
(f) opening of the mold (MO) and removing the molded non-crosslinked polymer material comprising at least one at least partially coated surface;
(g) optionally post-treating of the material obtained after step (f),
wherein the coating composition (C1) comprises
(i) at least one solvent L;
(ii) at least one compound of the general formula (I) 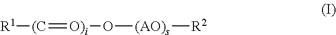
in which R¹ is a saturated or unsaturated aliphatic hydrocarbon radical having 6 to 30 carbon atoms,
R² is H,
AO stands for one or more alkylene oxide radicals selected from the group consisting of ethylene oxide, propylene oxide and butylene oxide,
r is 0 or 1, and
s is 0 to 30;
(iii) at least one polysiloxane of the general formula (II) 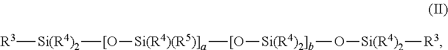
in which
R³ and R⁴, in each case independently of one another, are a methyl group or a (HO—CH₂)₂—C(CH₂—CH₃)—CH₂—O—(CH₂)₃—* radical,
R⁵ is a methyl group,
a is 0 or 1 to 10, and
b is 3 to 30;
(iv) at least one binder;
(v) at least one crosslinking agent; and
(vi) optionally at least one polyether-modified alkylpolysiloxane.

2. The process according to claim 1, wherein the coating composition (C1) comprises at least one compound of formula (Ia) 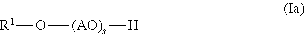
and at least one compound of formula (Ib) 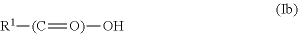
in which
R¹ is a saturated or unsaturated, aliphatic hydrocarbon radical having 6 to 30 carbon atoms,
R¹′ is a saturated or unsaturated, aliphatic hydrocarbon radical having 6 to 30 carbon atoms,
AO stands for one or more alkylene oxide radicals selected from the group consisting of ethylene oxide, propylene oxide and butylene oxide, and
S is 2 to 28.

3. The process according to claim 1, wherein the at least one compound of the general formula (I) is present in a total amount of 0.1 to 10 wt. %, based on the total weight of the coating composition (C1).

4. The process according to claim 1, wherein radical R³ in the general formula (II) is a (HO—CH₂)₂—C(CH₂—CH₃)—CH₂—O—(CH₂)₃—* radical and radicals R⁴ and R⁵ in the general formula (II) are each a methyl group.

5. The process according to claim 1, wherein a in the general formula (II) is 0 and b in the general formula (II) is 7 to 14.

6. The process according to claim 1, wherein the at least one polysiloxane of the general formula (II) in present in a total amount of 0.1 to 5 wt. %, based on the total weight of the coating composition (C1).

7. The process according to claim 1, wherein the coating composition (C1) is dried in process step (b) for a period of 20 seconds to 60 minutes at a temperature of 20 to 100° C.

8. The process according to claim 1, wherein the non-crosslinkable polymer composition (C2) is selected from the group consisting of expanded thermoplastic polyurethane particles, expandable thermoplastic polyurethane particles, non-crosslinkable thermoplastic polyurethane, non-crosslinkable polyvinyl chloride, non-crosslinkable polycarbonate, non-crosslinkable polystyrene, non-crosslinkable polyethylene, non-crosslinkable polypropylene, non-crosslinkable acrylonitrile butadienestyrene, non-crosslinkable polyoxymethylene, and non-crosslinkable polytetrafluoroethylene.

9. The process according to claim 8, wherein the expanded thermoplastic polyurethane particles have an average diameter of 0.2 mm to 20 mm, and/or wherein the expandable thermoplastic polyurethane particles have an average diameter of 0.2 to 10 mm.

10. The process according to claim 8, wherein expandable thermoplastic polyurethane particles comprise at least one blowing agent and optionally 5 to 80 wt. % organic and/or inorganic fillers, based on the total weight of the expandable thermoplastic polyurethane particles.

11. The process according to claim 8, wherein the non-crosslinkable thermoplastic polyurethane comprises at least one blowing agent or is free of blowing agents.

12. The process according to claim 8, wherein step (e-1) is performed at a temperature of 100 to 140° C.

13. The process according to claim 8, wherein step (e-2) is performed using steam at a temperature of 100 to 140° C. or using radiofrequency.

14. The process according to claim 13, wherein a radiofrequency of 3 to 8 kV at a temperature of at least 45° C. is used.

15. A molded non-crosslinked polymer material comprising at least one at least partially coated surface, produced by the process according to claim 1.

16. The process according to claim 2, wherein
R¹ is a saturated or unsaturated, aliphatic hydrocarbon radical having 12 to 22 carbon atoms,
R¹′ is an unsaturated, aliphatic hydrocarbon radical having 21 carbon atoms,
AO stands for ethylene oxide, and
S is 6 to 20.

17. The process according to claim 1, wherein the at least one compound of the general formula (I) is present in a total amount of 0.5 to 5 wt. %, based on the total weight of the coating composition (C1).

18. The process according to claim 1, wherein the at least one polysiloxane of the general formula (II) in present in a total amount of 0.5 to 4 wt. %, based on the total weight of the coating composition (C1).

19. The process according to claim 1, wherein the coating composition (C1) is dried in process step (b) for a period of 20 seconds to 25 minutes at a temperature of 20 to 70° C.

20. The process according to claim 1, wherein the non-crosslinkable polymer composition (C2) is selected from the group consisting of expanded thermoplastic polyurethane particles and non-crosslinkable thermoplastic polyurethane compositions.
